(19) United States
(12) Patent Application Publication
(10) Pub. No.: US 2022/0389685 A1
(43) Pub. Date: Dec. 8, 2022

(54) METHOD FOR DETERMINING SITUATIONAL AWARENESS IN WORKSITE

(71) Applicant: Novatron Oy, Pirkkala (FI)

(72) Inventors: Tuomas Kovanen, Pirkkala (FI); Antti Kolu, PIRKKALA (FI); Petri Moisio, Pirkkala (FI); Mikko Vesanen, Pirkkala (FI); Arto Anttila, Tampere (FI); Niko Haaraniemi, Pirkkala (FI)

(73) Assignee: Novatron Oy, Pirkkala (FI)

(21) Appl. No.: 17/773,018

(22) PCT Filed: Nov. 25, 2020
(86) PCT No.: PCT/EP2020/083352

§ 371 Date: Apr. 28, 2022

(30) Foreign Application Priority Data
Nov. 27, 2019 (FI) 20196022
Nov. 27, 2019 (FI) 20196023

(51) Int. Cl. E02F 9/26; G01S 19/01; G01S 17/66; G06V 20/52

(52) U.S. Cl. CPC E02F 9/261; G01S 19/01; G01S 17/66; G06V 20/52

(57) ABSTRACT

A method for determining situational awareness in a worksite includes setting at least one environment modelling apparatus (EM) at least one of: on a machine or external from the machine; setting at least one tracking apparatus (TA) at least one of: on the machine or external from the machine; acquiring data by the at least one tracking apparatus (TA); and acquiring data by the at least one environment modelling apparatus. Further, the method includes receiving, by at least one position determination unit (PDU), data related to the at least one tracking apparatus (TA) and data related to the at least one environment modelling apparatus (EM); and determining, by the at least one position determination unit (PDU), based at least in part on the received data, the location and orientation of the machine in the worksite.

### CROSS-REFERENCE TO RELATED APPLICATIONS

This application is a National Stage application of International Application No. PCT/EP2020/083352, filed Nov. 25, 2020, which claims benefit to Finnish Application No. 20196022, filed Nov. 27, 2019, and Finnish Application No. 20196023, filed Nov. 27, 2019, which are incorporated by reference herein in their entireties.

### BACKGROUND

### FIELD

The invention relates to a method for determining situational awareness in a worksite.

### SUMMARY

Different types of work machines may be utilized at different earth-moving work sites or construction sites for example for moving soil or rock material from one location to another or to lift or lower materials to be used in the constructions. Examples of this kind of work sites include for example substructure construction work sites or housing construction work sites for buildings and road construction work sites, the work sites like that forming some examples of typical worksites. The work machines like that are for example excavators and mobile cranes.

The work machines and the working tools of the work machines should be able to be positioned very accurately in the worksite in order to execute de-signed operations properly. The information regarding the accurate location of the work machine and the tool thereof may be shown to an operator of the work machine so that the operator may use the information when controlling the tool and the machine. This accurate location information of the machine and the tool thereof is especially important when it is utilized in semiautomatic or fully automatic work machines, i.e. work machines operating at least some time without a constant control by the operator of the machine, and whereby possible misplacement of the machine or its tool is not immediately rectified by the operator of the machine.

Generally automatic positioning of the machine may be based for example on a satellite-based positioning system GNSS (Global Navigation Satellite Systems), such as GPS (US), GLONASS (RU), Galileo (EU) or Compass (CN). Alternatively, the positioning of the work machine may be provided by means of a total station positioned to the worksite.

However, in every worksite there is not necessarily any or accurate enough satellite-based positioning system available, or the positioning system available is not sophisticated enough for high-precision determination of the location and orientation of the machine. Retrofitting of an older machine with a high-precision system is not necessarily very cost-effective. Also, a setup of the total station-based positioning system in the worksite may be laborious especially if the total station-based system should be removed from the worksite daily or many times each day.

In addition to the accurate positioning of the work machine in the worksite also a knowledge of a condition or state of the worksite, providing information depicting situational awareness in the worksite, would advance an efficient operation of the work machine and a progress of the worksite.

Therefore, there is a need for a simple positioning solution that also improves situational awareness in the worksite.

An object of the present invention is to provide a novel method for determining situational awareness in a worksite.

The invention is characterized by the features of the independent claim.

In the invention, for determining the situational awareness in the worksite, the determination of the location and orientation of the machine in the worksite is combined with providing knowledge of a condition or state of the worksite.

The positioning of the work machine in the worksite together with an acquisition of a condition or state of the worksite provide information depicting situational awareness in the worksite, advancing an efficient operation of the work machine and a progress of the worksite. This allows the control of the work machine to take into account also other work machines and alternating circumstances or unexpected incidents taking place not only in the execution of the work task presently being carrying out but as well in the work tasks to be carried out later.

Some embodiments of the invention are disclosed in the dependent claims.

According to an embodiment of the method for determining situational awareness in a worksite, the method comprises setting at least one environment modelling apparatus at least one of: on a machine or external from the machine, setting at least one tracking apparatus at least one of: on the machine or external from the machine, acquiring data by the at least one tracking apparatus, acquiring data by the at least one environment modelling apparatus, receiving by at least one position determination unit data related to the at least one tracking apparatus and data related to the at least one environment modelling apparatus, and determining by the at least one position determination unit, based at least in part on the received data, the location and orientation of the machine in the worksite.

According to an embodiment of the method, the method further comprises determining by the at least one position determination unit, based at least in part on the received data, at least one of: direction of travel or alternative direction of travel of the machine in the worksite.

According to an embodiment of the method, the method further comprises determining at least one of: accuracy level or validity of the determined location and orientation of the machine in the worksite.

According to an embodiment of the method, the data related to the at least one tracking apparatus comprises at least one of: locations of tracked marker points with respect to the tracking apparatus, locations of tracked reference points with respect to the tracking apparatus, inclination angle of the tracking apparatus, heading of the tracking apparatus, stability of the tracking apparatus, location and orientation of the tracking apparatus in at least one of: a machine coordinate system, a worksite coordinate system or a world coordinate system or at least one of: accuracy level or validity of at least one of the previous.

According to an embodiment of the method, the data related to the at least one environment modelling apparatus is at least one of: spatial data, locations of tracked marker points with respect to the environment modelling apparatus, locations of tracked reference points with respect to the environment modelling apparatus, inclination angle of the environment modelling apparatus, heading of the environment modelling apparatus, stability of the environment modelling apparatus, location and orientation of the environment modelling apparatus in at least one of: a machine coordinate system, a worksite coordinate system or a world coordinate system or at least one of: accuracy level or validity of at least one of the previous.

According to an embodiment of the method, the spatial data comprises at least one of: pictorial data, point cloud data or data with implicit or explicit reference to a location relative to at least one of: the worksite or the Earth.

According to an embodiment of the method, the method further comprises receiving by at least one environment modelling unit, an indication of a material delivery, material delivery base determined by first data related to at least one environment modelling apparatus covering an area of material to be placed, and material delivery complete determined by second data related to at least one environment modelling apparatus covering the area of material to be placed, and saving by the at least one environment modelling unit at least in part the data regarding the indication of the material delivery, the material delivery base and the material delivery complete as a material delivered.

According to an embodiment of the method, the method further comprises receiving by the at least one environment modelling unit one or more indications relating to at least one of: work phase or work stage of respective areas, and data related to the at least one environment modelling apparatus, and wherein, by taking into account the one or more indications, it is derived from the data related to the at least one environment modelling apparatus a georeferenced spatial data of respective areas, and saved at least in part the georeferenced spatial data.

According to an embodiment of the method, the step of saving at least in part the georeferenced spatial data further comprises determining, based at least in part on the data received from the at least one environment modelling apparatus, the areas the georeferenced spatial data of which is to be saved, and saving the georeferenced spatial data of the areas determined to be saved.

According to an embodiment of the method, the step of determining, based at least in part on the data received from the at least one environment modelling apparatus, the areas the georeferenced spatial data of which are to be saved, comprises detecting the areas where the georeferenced spatial data of the at least one environment modelling apparatus is obstacle-free and regarding the obstacle-free areas, the method further comprises comparing current accuracy of the determined location and orientation of the machine in the worksite with the accuracy of the determined location and orientation of the machine in the worksite in time of the previously saved georeferenced spatial data, and whether the current accuracy is above almost as good, updating the saved georeferenced spatial data in the obstacle-free areas.

According to an embodiment of the method, the method further comprises resolving, by the at least one position determination unit which determined the location and orientation of the machine in the worksite, data regarding at least one of: a tracking apparatus, an environment modelling apparatus, an object or another machine; and transmitting the data resolved at least one of: as part of data related to the respective tracking apparatus, environment modelling apparatus, object or another machine, or as data receivable by at least one position determination unit.

According to an embodiment of the method, the method further comprises initializing the tracking apparatus by determining location and orientation of the tracking apparatus in at least one of: the machine coordinate system or the worksite coordinate system if the tracking apparatus is set on at least one of: the machine or another machine, and determining location and orientation of the tracking apparatus in the worksite coordinate system if the tracking apparatus is set external from any machine.

According to an embodiment of the method, the method further comprises initializing the environment modelling apparatus by determining location and orientation of the environment modelling apparatus in at least one of: the machine coordinate system or the worksite coordinate system if the environment modelling apparatus is set on at least one of: the machine or another machine, and determining the location and orientation of the environment modelling apparatus in the worksite coordinate system if the environment modelling apparatus is set external from any machine.

According to an embodiment of the method, the determined situational awareness is at least one of spatial data, georeferenced spatial data, regional work phase data, regional work stage data, as-built data, at least one of: location, orientation, direction of travel or alternative direction of travel of any machine in the worksite, at least one of location, orientation or direction of travel or alternative direction of travel or surrounding at least one of: static or moving at least one of: machine, obstacle or object at least one of: to be avoided or of interest.

According to an embodiment of the method, the at least one tracking apparatus tracks with respect to the tracking apparatus locations of at least one of: at least one reference point in the worksite, at least one marker point attached to the machine or any other trackable marker attached to at least one of: the machine, the obstacle or the object; and the at least one environment modelling apparatus tracks with respect to the at least one environment modelling apparatus locations of at least one of: at least one reference point in the worksite, at least one marker point attached to the machine, any other trackable marker attached to at least one of: the machine, the obstacle or the object, or spatial data relating to the worksite.

According to an embodiment of the method, the method further comprises determining a minimum level of accuracy of the determined location and orientation of the machine in the worksite; determining a threshold level above the minimum level of accuracy, and wherein it is disabled the controls for moving an under carriage of the machine if the level of accuracy falls below the threshold level and if the work task in progress may be carried out without moving the under carriage.

According to an embodiment of the method, the data related to at least one of: the at least one tracking apparatus or the at least one environment modelling apparatus comprises at least one of: the data acquired by the respective apparatus, data from sensors installed on the respective apparatus, data from sensors installed on the attachment point of the apparatus, data resolved by at least one of: any position determination unit or any apparatus at least one of: by tracking the respective apparatus or as a result of any calculations relating to the respective apparatus or at least one of: accuracy level or validity of at least one of the previous.

According to an embodiment of the method, if the at least one tracking apparatus is set on the worksite and if it comprises a tracking device for tracking the location of the tracking apparatus with one or more GNSS antennas, the tracking apparatus further comprises at least one of: a camera, a stereocamera, a lidar, a radar or a tachymeter as a tracking device.

According to an embodiment of the method, determination, by the at least one position determination unit, of the location and orientation of the machine in the worksite is additionally based at least in part on data received from one or more sensors installed on at least one of: the machine or another machine, wherein the sensors comprise at least one of: position, orientation, inclination, heading or distance travelled of at least one of: the machine or another machine.

According to an embodiment of the method, the machine is an excavator, and determination, by the at least one position determination unit, of the location and orientation of the machine in the worksite is additionally based at least in part on data received from one or more sensors installed on the upper carriage of at least one of: the machine or another machine, wherein the sensors comprise at least one of: position, orientation, inclination or heading of the upper carriage of at least one of: the machine or another machine.

### BRIEF DESCRIPTION OF THE DRAWINGS

In the following the invention will be described in greater detail by means of preferred embodiments with reference to the accompanying drawings, in which

FIG. 1 shows schematically a side view of an excavator;

FIG. 2 shows schematically an upper view of a worksite;

FIG. 3 shows schematically some components of a positioning system for determining location and orientation of a machine in a worksite;

FIG. 4 shows schematically an embodiment of a method for determining location and orientation of a machine in a worksite;

FIG. 5 shows schematically a reference marker with number of reference points to be arranged in the worksite for the determination of location and orientation of a machine in a worksite;

FIG. 6 shows schematically a marker with number of marker points to be arranged on the machine for the determination of location and orientation of a machine in a worksite;

FIG. 7 shows schematically an embodiment of a tracking apparatus;

FIG. 8 shows schematically sensors possibly arranged in a machine and/or a tracking apparatus;

FIG. 9 shows schematically some possible tracking states of the tracking apparatus;

FIG. 10 shows schematically an upper view of a second worksite;

FIG. 11 shows schematically an embodiment of another method for determining location and orientation of a machine in a worksite;

FIG. 12 shows schematically an upper view of a third worksite;

FIG. 13 shows schematically an upper view of a fourth worksite;

FIG. 14 shows schematically some components of another positioning system for determining location and orientation of a machine in a worksite with situational awareness in the worksite;

FIG. 15 shows schematically an embodiment of a further method for determining location and orientation of a machine in a worksite;

FIG. 16 shows schematically data related to at least one tracking apparatus;

FIG. 17 shows schematically data related to at least one environment modelling apparatus; and

FIG. 18 shows schematically data depicting situational awareness in a worksite.

For the sake of clarity, the figures show some embodiments of the invention in a simplified manner. Like reference numerals identify like elements in the Figures.

### DETAILED DESCRIPTION

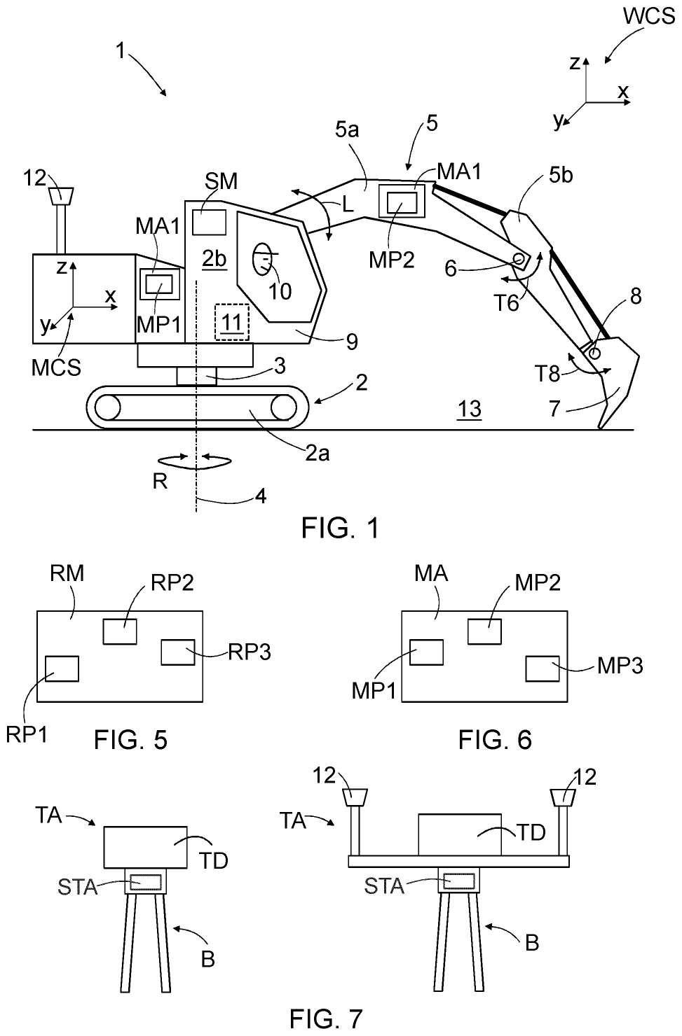

FIG. 1 is a schematic side view of an excavator 1 at a worksite 13 wherein the excavator 1 is intended to be operated. The excavator 1 is one example of a work machine in connection with which the method and positioning system disclosed, as well as the method for determining situational awareness in the worksite 13, may be utilized. The worksite 13 comprises at least one area or space at which the active work is going to take place. Depending on the nature or character of the worksite 13, the worksite 13 may also comprise, in addition to the area or space at which the active work is going to take place, also one or more areas or spaces, that are typically surrounding areas or spaces, which may have impact on the operations at the area or space at which the active work is going to take place and/or to which areas or spaces it may be affected by operations taking place at the area or space at which the active work is going to take place. Especially in urban environment a work machine may need to work outside the actual or official determined worksite, thus in this description the worksite 13 may extend several meters beyond the area and/or space denoting the actual or official determined worksite, thus bringing the need to track or detect the barriers and travellers nearby the actual or official determined worksite as well. Further, the worksite 13 may also comprise at least some parts of the surroundings of the worksite 13, which surroundings are not unambiguously indicated, for example by respective visually informative signs, being part of the worksite 13.

The excavator 1 comprises a movable carriage 2 comprising an under carriage 2a, i.e. a lower carriage 2a, and an upper carriage 2b. The lower carriage 2a comprises caterpillar bands but could alternatively be provided with wheels. The upper carriage 2b is connected to the lower carriage 2a by means of a rotation axle 3 of the upper carriage 2b. The upper carriage 2b may be rotated relative to the lower carriage 2a around a rotation axis 4 as shown schematically with an arrow R. The rotation axis 4 coincides to a centre axis of the rotation axle 3.

The excavator 1 further comprises a boom 5 connected at the upper carriage 2b, whereby the boom 5 is arranged to turn together with the upper carriage 2b. The boom 5 may comprise at least a first boom part 5a. The boom 5 may also comprise further boom parts, such as a second boom part 5b. The boom 5 may be lifted and lowered relative to the upper carriage 2b as shown schematically with an arrow L.

The second boom part 5b may be connected to the first boom part 5a by means of a joint 6, allowing the second boom part 5b to turn about the first boom part 5a as shown schematically with an arrow T6. At a distal end of the second boom part 5b there is a working tool, in this case a bucket 7, and between the bucket 7 and the second boom part 5b there may be a joint 8, allowing the bucket 7 to be turn about the second boom part 5b as shown schematically with an arrow T8. In connection with the joint 8 there may also be joints or mechanisms allowing the bucked to be tilted in a sideward direction, for example.

On the carriage 2 there may be a control cabin 9 for an operator 10 of the excavator 1. The control cabin 9 may, for example, be provided with a moving arrangement allowing a vertical position of the control cabin 9 to be adjusted relative to the carriage 2.

The excavator 1 further comprises at least one control unit 11 which is configured to control, in response to received control actions, operations of the excavator 1, such as operations of the carriage 2, the boom 5 and the bucket 7.

The excavator 1 may further comprise a number of satellite receiving devices, such as antennas 12, if the excavator 1 is intended to be able to utilize a kind of a satellite-based positioning system GNSS (Global Navigation Satellite Systems). Antennas 12 may for example be placed on the upper carriage 2b.

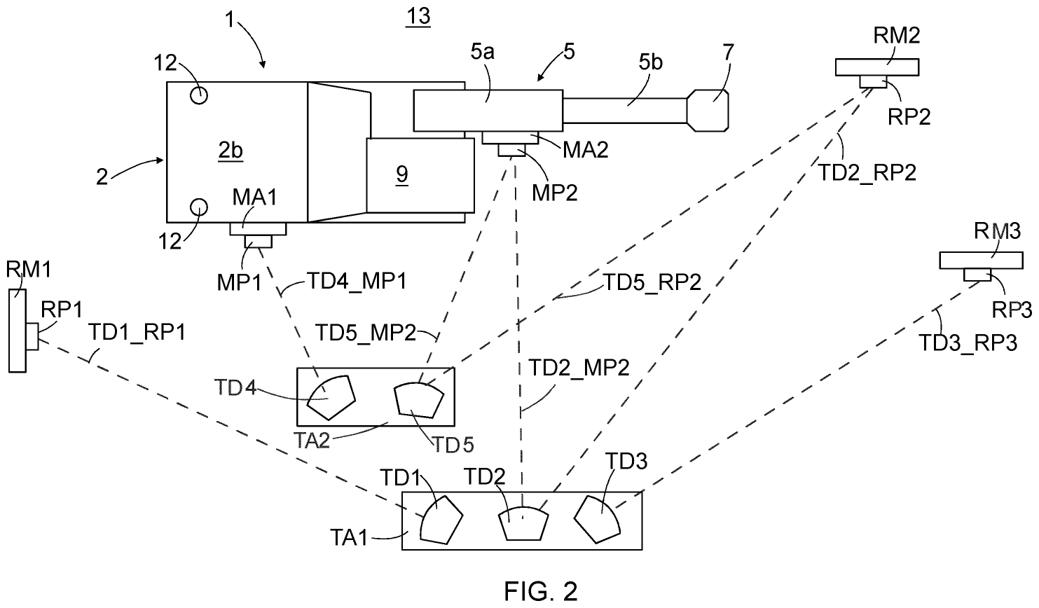

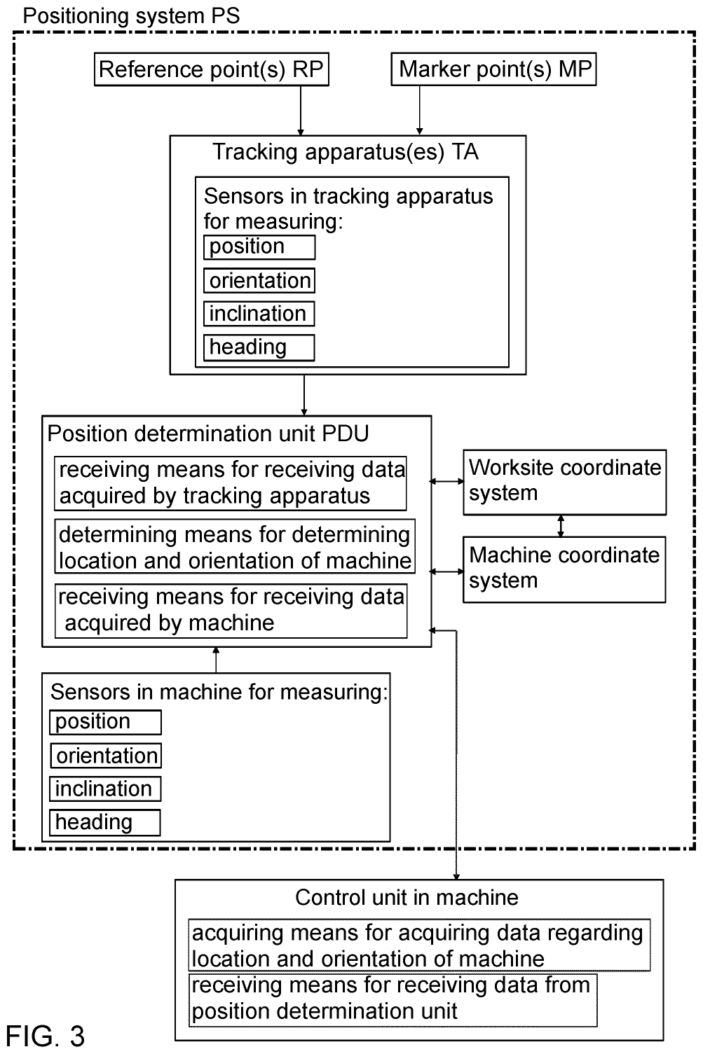

FIG. 2 shows schematically an upper view of the worksite 13 wherein the excavator 1 is about to operate. In the example of FIG. 2 there is at the worksite 13 the excavator 1 as well as some equipment of the positioning system PS for determining the location and orientation of the excavator 1, or alternatively some other machine, in the worksite coordinate system WCS. Also a control system of the excavator 1 may comprise a machine coordinate system MCS of its own, whereby the machine coordinate system MCS may be fixed to machine with marker points MP arranged in the machine such that the positioning provided by the positioning system PS allows the machine coordinate system MCS to be identified with respect to the worksite coordinate system WCS. The worksite coordinate system WCS and the machine coordinate system MCS are shown schematically in FIG. 1. FIG. 3, in turn, shows schematically an embodiment of the positioning system PS with some additional equipment related to the positioning system PS.

The positioning system PS comprises at least one reference marker RM, i.e. one or more reference markers RM set in the worksite 13. The reference marker RM arranged in the worksite 13 may for example be aruco marker, QR-code, light emitting marker, light reflecting marker, prism or the like. Each reference marker RM provides at least one reference point RP, i.e. one or more reference points RP, whereby there is at least one reference point RP in the worksite 13 determined in the worksite coordinate system WCS for the determination of the location and orientation of the machine. For the sake of clarity, determining and/or defining and/or calculating an orientation of a machine and/or an apparatus in worksite and/or in a coordinate system in this description means the determining the needed three angles, such as roll, pitch and yaw, to accurately determine in which position the machine and/or the apparatus is in the worksite and/or the coordinate system. Thus, when a location of at least one point and/or spot of a machine and/or an apparatus, which point and/or spot is known in its own coordinate system, is or may be determined and an orientation of the machine and/or the apparatus is or may be determined, the machine and/or the apparatus may be fixed and/or placed and/or set and/or positioned accurately into the worksite or the coordinate system.

In the example of FIG. 2 there are schematically shown three reference markers RM, i.e. a first reference marker RM1, a second reference marker RM2 and a third reference marker RM3 set or arranged in the worksite 13. Each reference marker RM1, RM2, RM3 comprises one reference point RP, i.e. the first reference marker RM1 comprises a first reference point RP1, the second reference marker RM2 comprises a second reference point RP2 and the third reference marker RM3 comprises a third reference point RP3. The specific reference point RP may be provided by a specific point in the aruco marker or by a specific light emitting device in the light emitting marker, for instance. In the example of FIG. 5 it is shown schematically a reference marker RM with three reference points RP, i.e. a first reference point RP1, a second reference point RP2 and a third reference point RP3. Each of the reference points RP are identifiable and the locations of the reference points RP are determined in the worksite coordinate system WCS. Thus, having an identification data of a reference point RP, the location of the reference point RP in the worksite coordinate system WCS may be determined.

The positioning system PS further comprises at least one marker MA, i.e. one or more markers MA set on the machine, i.e. in the excavator 1. The marker MA arranged on the machine may for example be aruco marker, QR-code, light emitting marker such as optitrack, light reflecting marker or the like. Each marker MA provides at least one marker point MP, i.e. one or more marker points MP, whereby there is at least one marker point MP on the machine for the determination of the location and orientation of the machine. Each of the marker points MP of each machine are identifiable and the locations of the marker points MP are determined in the machine coordinate system MCS so that the positioning system PS positioning and identifying the marker points MP may be positioning the machine coordinate system MCS, i.e. the machine. Thus, having an identification data of a marker point MP, the location of the marker point MP in the machine coordinate system MCS may be determined.

In the example of FIG. 1 there are schematically shown two markers MA, i.e. a first marker MA1 and a second marker MA2, arranged on the machine. Each marker MA1, MA2 comprises one marker point MP, i.e. the first marker MA1 comprises a first marker point MP1 and the second marker MA2 comprises a second marker point MP2. The specific marker point MP may be provided by a specific point in the aruco marker or by a specific light emitting device in the light emitting marker, for instance. In the example of FIG. 6 it is shown schematically a marker MA with three marker points MP, i.e. a first marker point MP1, a second marker point MP2 and a third marker point MP3.

The positioning system PS further comprises at least one tracking apparatus TA, i.e. one more tracking apparatuses TA arranged in the worksite 13. The tracking apparatus TA tracks or monitors reference points RP and marker points MP and especially the identification data and locations thereof relative to the tracking apparatus TA in the worksite 13. Based on the initialization of the tracking the tracking apparatus TA tracks the locations of the at least one identified reference point RP in the worksite 13 and the at least one identified marker point MP in the machine. Thus, by using the identification data of the at least one reference point RP the positioning system PS is able to locate the reference point RP in the worksite coordinate system WCS, by using the identification data of the at least one marker point MP the positioning system PS is able to locate the marker point MP in the machine coordinate system MCS and after the positioning system PS has tracked the location of the at least one identified reference point RP and at least one identified marker point MP with respect to it, the positioning system PS is able to determine the location and orientation of the machine coordinate system MCS, i.e. the machine, in the worksite coordinate system WCS. The tracking apparatus TA comprises at least one tracking device TD, i.e. one or more tracking devices TD to provide a visual communication between the tracking apparatus TA and reference points RP and marker points MP. Furthermore, the tracking apparatus TA comprises means, such as an input-output unit, for receiving and/or sending information.

The tracking or monitoring takes place or is carried out through a visual communication between the tracking apparatus TA and respective reference points RP and marker points MP. In the example of FIG. 2 there are two tracking apparatuses TA arranged in the worksite 13, i.e. a first tracking apparatus TA1 and a second tracking apparatus TA2. The first tracking apparatus TA1 comprises three tracking devices, i.e. a first tracking device TD1, a second tracking device TD2 and a third tracking device TD3 to provide at some time instant a first visual connection TD1_RP1 between the first tracking device TD1 and the first reference point RP1, a second visual connection TD2_RP2 between the second tracking device TD2 and the second reference point RP2 and a third visual connection TD3_RP3 between the third tracking device TD3 and the third reference point RP3. Additionally, the second tracking device TD2 is arranged to provide a fourth visual connection TD2_RM2 between the second tracking device TD2 and the second marker point MP2. The second tracking apparatus TA2 comprises two tracking devices, i.e. a fourth tracking device TD4 to provide a fifth visual connection TD4_MP1 between the fourth tracking device TD4 and the first marker point MP1 and a fifth tracking device TD5 to provide a sixth visual connection TD5_MP2 between the fifth tracking device TD5 and the second marker point MP2. Additionally, the fifth tracking device TD5 is arranged to provide a seventh visual connection TD5_RP2 between the fifth tracking device TD5 and the second reference point RP2.

In the embodiment of FIG. 2 there are shown two tracking apparatuses, i.e. the first tracking apparatus TA1 provided with three tracking devices TD1, TD2, TD3 to track at some time instant the reference point RP1, RP2, RP3 locations and the second marker point MP2 location, and the second tracking apparatus TA2 provided with two tracking devices TD4, TD5 to track at some time instant the marker point MP1, MP2 locations and the second reference point RP2 location. However, each of the tracking apparatuses TA1, TA2 could comprise only a single tracking device to track the respective reference point RP1, RP2, RP3 locations and marker point MP1, MP2 locations. Furthermore, the positioning system could comprise only a single tracking apparatus with one or more tracking devices TD to track the reference point RP1, RP2, RP3 and marker point MP1, MP2 locations. Further, if two or more tracking apparatuses TA, e.g. TA1, TA2, are at known orientation and location with respect to each other, it corresponds to an arrangement having one tracking apparatus TA and all the tracking devices TD (such as TD1, TD2, TD3, TD4, TD5) of the two or more tracking apparatuses TA (such as TA1, TA2), whereby, in cases TA1 manages to track only reference points RP and TA2 manages to track only marker points MP the combination of all the acquired data enables the determination of the location and orientation of the machine in the worksite 13.

The tracking device TD1, TD2, TD3, TD4, TD5 is a device capable to establish or provide a visual connection between the tracking apparatus TA and the at least one reference point RP and/or the at least one marker point MP. According to an embodiment the tracking device is a camera, a stereocamera, a lidar or a tachymeter.

The camera and/or the stereocamera may be equipped with a lens or an objective having such a focal point that the camera and/or the stereocamera is capable of establishing an accurate visual connection to objects remaining substantially close to the camera and/or the stereocamera or farther from the camera and/or the stereocamera, such as objects locating in the worksite 13 substantially farther away from the camera and/or the stereocamera than the machine. The camera and/or the stereocamera may therefore be capable of providing zooming effect to the objects locating substantially far away from the tracking apparatus TA.

According to an embodiment of the tracking apparatus TA, the tracking apparatus TA comprises a camera, or some other tracking device TD, and a base B for the camera or some other tracking device, whereby the tracking apparatus TA may be set at a specific fixed position at a ground in the worksite 13. FIG. 7 shows schematically, on the left, this kind of tracking apparatus TA.

In order to gain high accuracy using one camera, or some other tracking device TD, tracking apparatus TA, the tracked reference points RP and marker points MP should be farther apart from each other and/or they may not be too far away from the tracking apparatus TA. Using one camera, there should preferably be at least four reference points RP forming a plane and at least four marker points MP forming a plane as well. Using two, three or more tracking devices TD in tracking apparatus TA, the distances between the tracking apparatus TA and the reference points RP and marker points MP may be longer and the amount of tracked reference points RP and marker points MP may be smaller. In other words, the more tracking devices TD there is, the more tracked reference points RP there is, the more tracked marker points MP there is and the less distance between the tracking apparatus TA and the tracked reference points RP and the tracked marker points MP there are, the higher the accuracy is. Bearing in mind that the locations of the tracked reference points RP compared to each other influence on the accuracy, as well as the locations of the tracked marker points MP compared to each other influence on the accuracy. Preferably, each tracking apparatus TA having a number of tracking devices TD, i.e. one or more tracking devices, tracks constantly at least one reference point RP and at least one marker point MP.

According to another embodiment of the tracking apparatus TA, the tracking apparatus TA may comprise a base that is capable to move within boundaries of the worksite 13, whereby a position of the tracking apparatus TA in the worksite 13 may be easily changed. This kind of tracking apparatus TA may for example be a drone provided with two or more tracking devices TD. A control unit of the drone may be configured in such a way that the drone is not allowed to exceed the boundaries of the worksite 13. During the determination of location and orientation of a machine in the worksite 13 the drone is preferably stationary. Alternatively, the drone may be stationary only in times when a threshold level regarding requested accuracy of position and orientation of a machine may not otherwise be exceeded.

The base B of the tracking apparatus TA may be adjustable, whereby an alignment of the tracking apparatus TA may be adjusted by adjusting the alignment of the base B. Therefore, according to an embodiment of the positioning system PS, at least one of the tracking devices TD may be installed on an adjustable base. The adjustable base of the tracking device TD allows the orientation of the base B and thereby the orientation of the tracking device TD to be adjusted conveniently by, for example, taking into account the area where the machine will be working and/or the locations of the nearest reference points RP.

According to an embodiment of the positioning system, the tracking apparatus TA comprises means for acquiring data relating to the orientation of each of the tracking devices TD on adjustable bases B with respect to the tracking apparatus TA. When the orientation of the tracking device TD with respect to the tracking apparatus TA is known, the position and orientation of the machine may be determined accurately. The adjustment of the base B may be automated or remote controlled, but it may also be manually operated, whereby there may be in the base B a scale division to indicate the orientation of the base B, for example, mounting points selectable in the direction of rotation, for example, in every 5 to 15 degrees.

The positioning system PS further comprises at least one position determination unit PDU, i.e. one or more position determination units PDU. The position determination unit PDU comprises receiving means for receiving data acquired by the at least one tracking apparatus TA. The data acquired by the at least one tracking apparatus TA comprises identification data for identifying reference points RP and marker points MP as well as the locations thereof relative to the tracking apparatus TA, i.e. the locations of the reference points RP identified and the locations of the marker points MP identified relative to the location of the detecting tracking apparatus TA, the identification data associating each specific reference point RP in the worksite coordinate system WCS and each specific marker point MP in the machine coordinate system MCS with respective location data of each reference point RP and each marker point MP relative to the tracking apparatus TA.

The locations relative to the location of the tracking apparatus are, for example, three dimensional coordinates in the coordinate system of the tracking apparatus. Alternatively, the locations may be three-dimensional coordinates in the worksite coordinate system WCS and/or three-dimensional coordinates in the machine coordinate system MCS.

The position determination unit PDU further comprises determining means for determining, based at least in part on the received data, i.e. based at least in part on the data acquired by the tracking apparatus TA, the location and orientation of the machine in the worksite coordinate system WCS. If there is also available the machine coordinate system MCS fixed to the machine, the location and orientation of the machine in the worksite coordinate system WCS may be transformed to the location and orientation of the worksite in the machine coordinate system MCS to implement work tasks to be carried out by the machine.

The at least one position determination unit PDU may be implemented by a combination of hardware and software. The implementation comprises an input/output-unit to communicate with other devices connected with the position determination unit PDU and a microprocessor or some other processing means capable to carry out a computer program that is configured to process the data received by the position determination unit PDU. The implementation may also comprise at least one memory unit to store at least temporarily the data received by the position determination unit PDU and/or the data to be sent forward from the position determination unit PDU.

The at least one position determination unit PDU may for example reside in a computer reachable by any wired or wireless network, and/or the machine and/or the at least one tracking apparatus TA. When the position determination unit PDU resides in the computer reachable by any wired or wireless network, the physical location of the position determination unit PDU may be selected freely, the position determination unit PDU may thus be inside or outside of the worksite 13. When the position determination unit PDU resides in the machine, it may for example be implemented in the control unit 11 of the machine. When the position determination unit PDU resides in the at least one tracking apparatus TA, the tracking apparatus TA is configured to comprise necessary means to implement the operation of the position determination unit PDU.

In the case of the at least one position determination unit PDU residing in a computer reachable by any wired or wireless network or in the at least one tracking apparatus TA, or at least one position determination unit PDU not residing in the control unit of the machine, the machine comprises at least one control unit, such as the control unit 11, acquiring data regarding the location and orientation of the machine, wherein the control unit is configured to select at least one position determination unit PDU from which it receives the determined location and orientation of the machine in the worksite 13.

According to an embodiment, at least one position determination unit PDU comprises receiving means for receiving data acquired by the machine. The data acquired by the machine may for example regard to data acquired by at least one sensor SM (FIG. 1), i.e. one or more sensors SM possibly installed in the machine for determining position and/or orientation and/or inclination and/or heading of the machine. The one or more sensors SM possibly installed in the machine are discussed in more detail later.

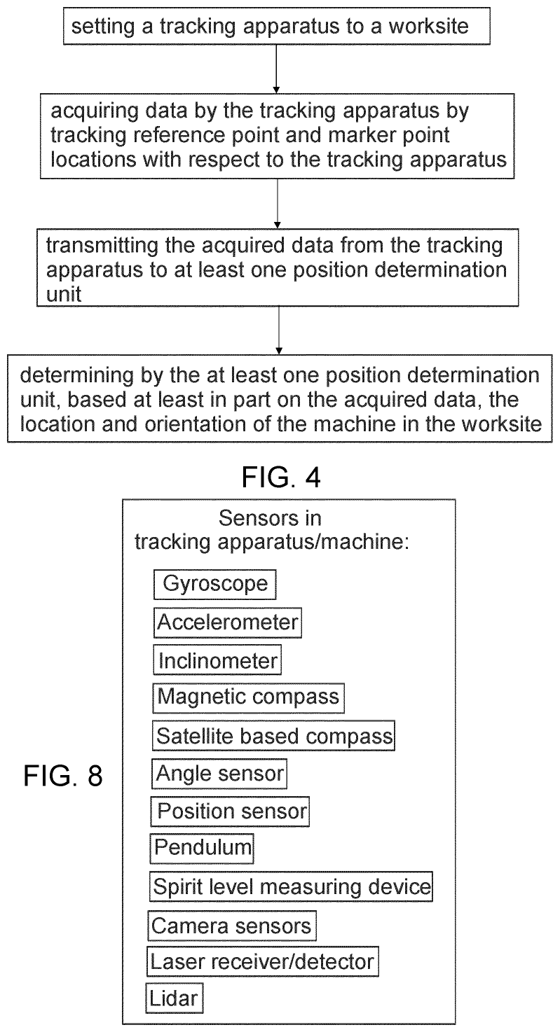

When the location and orientation of the machine in the worksite 13 is determined, at least one marker point MP is arranged on the machine and at least one reference point RP is arranged in the worksite 13. The method further comprises arranging at least one tracking apparatus TA in the worksite 13, for acquiring data by tracking reference point RP locations and by tracking marker point MP locations with respect to the tracking apparatus TA. The data acquired by the tracking apparatus TA is transmitted from the tracking apparatus TA to the position determination unit PDU. The position determination unit PDU determines, based at least in part on the acquired data received from the tracking apparatus TA, the location and orientation of the machine in the worksite 13. FIG. 4 shows schematically an embodiment of the method for determining location and orientation of the machine in the worksite 13.

The installation of the tracking apparatus TA at the worksite 13 may be mplemented only by arranging the tracking apparatus TA in the worksite 13, and thereafter the tracking apparatus TA may itself track or find the at least one reference point RP and the at least one marker point MP in the worksite 13 and acquiring data about the locations of the at least one reference point RP and the at least one marker point MP in the worksite 13. There is thus no need to accurately adjust or position the tracking apparatus TA in the worksite 13 unlike generally known tachymeter or similar device.

Basically, the tracking apparatus TA is configured to find all the reference points RP and the marker points MP that are in an operating range of the tracking apparatus TA. If there is not any reference point RP or any marker point MP set in the worksite 13, the tracking apparatus TA is not able to acquire data from the at least one reference point RP and/or from the at least one marker point MP and will therefore not provide the respective data about the location of the at least one reference point RP and/or the at least one marker point MP. In case where the tracking apparatus TA is arranged in the worksite 13 and it is unable to identify any reference points RP and/or marker points MP, the tracking apparatus may signal it by any known means. Also, the tracking apparatus may signal by any known means how many reference points and/or marker points MP it is able to identify from its current location. Thus, the person who is arranging the tracking apparatus TA in the worksite may get feedback regarding what kind of place the person is arranging the tracking apparatus TA to. The feedback may indicate the accuracy level reachable by the current location of the tracking apparatus TA.

The minimum requirement for the tracking apparatus TA to start assisting in determining the location and orientation of a machine is to identify at least one reference point RP and track its location with respect to the tracking apparatus and to identify at least one marker point MP and track its location with respect to the tracking apparatus and transmit the data regarding the tracked reference point RP identification and tracked marker point MP identification and their tracked locations with respect to the tracking apparatus to at least one position determination unit PDU. If the minimum requirements are not fulfilled, the tracking apparatus TA may indicate it.

Further, in addition to all the information transmitted by the tracking apparatus TA to the position determination unit PDU, the position determination unit PDU need to acquire the location information of the identified reference point RP in the worksite coordinate system WCS and to acquire the location information of the identified marker point MP location in the machine coordinate system MCS. The location information relating to the reference points RP in the worksite coordinate system WCS and the marker points MP in the machine coordinate system MCS may be received by the position determination unit PDU in any known method.

To start determining the location and orientation of a machine, the position determination unit PDU may need additional information. The additional information needed depends on how much information the position determination unit PDU receives from a tracking apparatus TA.

Thus, regarding the arranging the tracking apparatus TA, it need be arranged such that it is able to identify at least one reference point RP and at least one marker point MP. The person arranging the tracking apparatus TA may be aware of that the machine has not arrived in the worksite 13 yet, so if the tracking apparatus TA informs it cannot find any marker points MP, the person may ignore that information. Or, if some temporary barrier prevents the tracking apparatus TA to identify one or more reference points RP and it leads to a situation that the tracking apparatus TA is not able to identify any reference point RP, the person may ignore that information and be aware that the tracking may begin only after the temporary barrier has been moved away.

According to an embodiment of the positioning system PS, at least one tracking apparatus TA comprises at least one sensor STA (FIG. 7), i.e. one or more sensors STA for determining position and/or orientation and/or inclination and/or heading of the tracking apparatus TA. The data including the information about the position and/or orientation and/or inclination and/or heading of the tracking apparatus TA is also considered to be data acquired by the tracking apparatus TA, whereby the data acquired by the tracking apparatus TA and communicated to the position determination unit PDU may also comprise the data including the information about the position and/or orientation and/or inclination and/or heading of the tracking apparatus TA.

According to an embodiment of the positioning system PS, the machine comprises at least one sensor SM (FIG. 1), i.e. one or more sensors SM for determining position and/or orientation and/or inclination and/or heading of the machine. The sensors in the machine may also include sensors relating to the determination of the orientation of the working tool of the machine. The effect of this embodiment is that in the event of the visual communication lacking between the tracking apparatus TA and the at least one reference point RP in the worksite 13 and/or the at least one marker point MP in the machine, for example due to an obstacle occurring between the machine and the at least one reference point RP and/or the marker point MP, the machine may still be able to continue, at least to some time, the operation thereof because of information acquired by the at least one sensor SM in the machine. The machine may for example remain at its current state which has been already determined by the position determination unit PDU before the obstacle occurring between the tracking apparatus TA and the at least one reference point RP and/or the marker point MP and continue to determine or track the position of the working tool relative to the machine. The time period how long the machine may be able to continue its operation may depend on the accuracy required at current task and the data acquired by the tracking apparatus TA before the obstacle occurring between the machine and the at least one reference point RP and/or the at least one marker point MP. The time period may as well depend on how accurate the at least one sensor SM in the machine is as well as how many sensors SM there are. Another effect relating to that the sensors in the machine may also include sensors relating to the determination of the orientation of the working tool of the machine is that if one or more marker points MP reside a place that is not fixedly connected to the part of the machine where, for example, the origin of the machine coordinate system MCS locates, the position determination unit PDU needs the information on how was the place oriented with respect to the machine coordinate system MCS or which was the location of the marker point MP in question in machine coordinate system MCS in the exact time of tracking. This kind of places may be found, for example, from the boom 5 of the excavator 1, where, for example, MP2 of FIG. 1 resides.

The one or more sensors in the machine and/or in the tracking apparatus TA may be at least one of: a gyroscope, an accelerometer, an inclinometer, a magnetic compass, a satellite-based compass, an angle sensor, a position sensor, a pendulum, a spirit level measuring device and any other sensor, such as camera sensors, laser receiver/detector or lidar, suitable for the purpose of determining at least one of position, location and orientation of at least one of an object and one or more objects attached to each other. FIG. 8 shows schematically some of these sensors. When considering for example the excavator 1, the term object herein refers to the boom 5, the boom parts 5a, 5b thereof and the working tool, such as the bucket 7. In the excavator 1 the sensors are preferably selected in such a way that it is possible to determine the mutual orientation of the under carriage 2a and upper carriage 2b as well as the orientation of the boom 5 and/or the parts 5a, 5b thereof and the working tool, such as the bucket 7, relative to the under carriage 2a and upper carriage 2b. When considering for example the excavator 1, the term object herein refers to the mutual orientation of the tracking devices TD in the tracking apparatus TA and mutual orientation of the tracking device TD and a possible base B thereof.

According to an embodiment the tracking apparatus TA further acquires data relating to stability of the tracking apparatus TA. The stability of the tracking apparatus describes reliability of the data acquired by the tracking apparatus.

According to an embodiment for acquiring data relating to the stability of the tracking apparatus TA, the tracking apparatus TA comprises at least one gyroscope and/or at least one accelerometer for determining the stability of the tracking apparatus TA. The at least one gyroscope and/or the at least one accelerometer may be used to determine for example swinging or shaking of the tracking apparatus TA, an amount of swinging or shaking of the tracking apparatus TA depicting the stability of the tracking apparatus TA which, in turn, describes the accuracy of the data acquired by the tracking apparatus TA.

According to a further embodiment for acquiring data relating to the stability of the tracking apparatus TA, it may be consecutively observed from the data acquired by the tracking apparatus TA relating to the at least one reference point RP. According to an embodiment like this, the position determination unit PDU, for example, may be configured to determine a variation of the data acquired by the tracking apparatus TA, and in case of the variation being significant, i.e. higher than the accuracy needed to carry out the work, it may be assumed that at least one of the reference point RP and the tracking apparatus TA is swinging or shaking, whereby the accuracy of the data acquired by the tracking apparatus TA may be lower than expected. Being significant may depend on the current accuracy needed. The accuracy for the specific work task may for example be set in a building information model (BIM-model) set for the worksite 13. The position determination unit PDU may indicate the variation level, for example, in millimetres and/or in degrees and the operator may take it into account as lowered accuracy. Alternatively, the PDU may analyse the data acquired by the tracking apparatus TA and indicate the operator the cause of the variation.

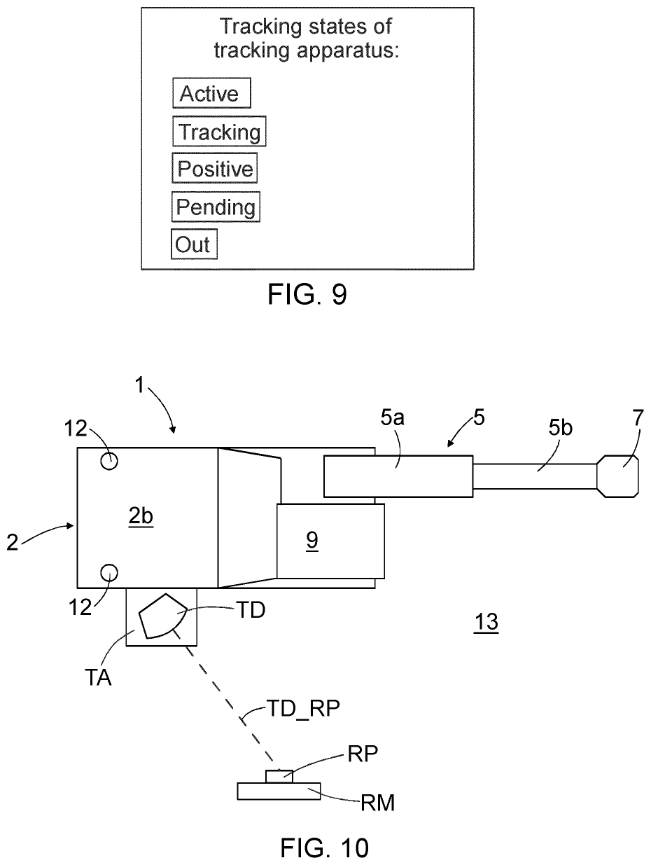

According to an embodiment a tracking state of the tracking apparatus TA is to be determined. The tracking state of the tracking apparatus TA describes a current prevailing operation state of the tracking apparatus TA. The tracking state of the tracking apparatus TA may be determined based on the data acquired by the tracking apparatus TA. The operation of the tracking apparatus TA may comprise at least the states Active, Tracking, Positive, Pending and Out, one stage of those prevailing at a time. FIG. 9 shows schematically some possible tracking states of the tracking apparatus TA.

When the tracking apparatus TA is on Active-state, the tracking apparatus TA acquires data by tracking the reference point RP and the marker point MP locations and transmits the acquired data forward to the position determination unit PDU. The tracking apparatus TA does not, however, provide any indication about the accuracy, reliability or validity of the acquired data.

When the tracking apparatus TA is on Tracking-state, the tracking apparatus TA acquires data by tracking the reference point RP and the marker point MP locations as well as acquires data from the sensors STA installed on the tracking apparatus TA and transmits the acquired data forward to the position determination unit PDU. Additionally, the tracking apparatus TA is actively conscious, for example, based on the determined accuracy and/or the amount of the acquired data as disclosed above, that it is capable of tracking a point and/or spot of any kind in the worksite coordinate system WCS accurately, i.e. correctly enough. Alternatively, based on what amount and which kind of sensors STA (disclosed above) are installed on the tracking apparatus TA, there may be determined the minimum amount of reference points RP and/or marker points MP to be tracked in each situation to be able to deem that the tracking apparatus TA is on Tracking-state. Thus, if it is tracked at least the minimum amount of reference points RP and/or marker points MP, the tracking apparatus is on Tracking-state and otherwise it is in some other state.

When the tracking apparatus TA is on Positive-state, the tracking apparatus TA acquires data by tracking reference point RP and marker point MP locations and transmits the acquired data forward to the position determination unit PDU. Additionally, the tracking apparatus TA is conscious of that it is operating correctly but for some reason, the correct operation of the tracking apparatus TA cannot be verified. One of the reasons may be that while being on Tracking-state, the minimum amount of tracked reference points RP is not fulfilled but, for example, the sensors installed on the tracking apparatus TA are able to verify that the stability of the tracking apparatus TA has not changed to a lower level after the situation the tracked reference points RP dropped below the minimum amount. The reason for this kind of situation may be, for example, people walking between one or more tracked reference points RP and the tracking apparatus TA. If this kind of situation lasts too long, the tracking state will be deemed to Active-state or, for example, someone approached to the tracking apparatus TA to shut it down.

When the tracking apparatus TA in on Out-state, the tracking apparatus TA is out of operation. It may, for example, have been shut down.

When the tracking apparatus TA in on Pending-state, the tracking apparatus TA is initializing its operation and changing its state from the Out-state towards the Tracking-state or the Active-state.

According to an embodiment the tracking apparatus TA is configured to determine the tracking state thereof and the tracking apparatus TA is further configured to transmit to the position determination unit PDU the tracking state and/or a change in the tracking state. The tracking apparatus TA may thus comprise necessary data processing means to identify its state and to transmit the state information forward.

According to an embodiment an availability of location-based features of the machine is dependent on the tracking state. According to this embodiment it is possible, depending on the tracking state of the tracking apparatus TA, that there is not available for the machine any position data at all or position data is not sufficient enough for work tasks requiring high accuracy, whereby the work task, that require utilizing position data the needed accuracy of which is above the current accuracy available, cannot be carried out but still it may be possible to carry out some other work tasks requiring accuracy that is equal or below current accuracy available. As well, some work tasks may require high certainty in minimum level of accuracy, thus, these work tasks may be unavailable if the tracking state is not Tracking. Alternatively, if the machine has many sensors SM assisting the position determination unit PDU, also Active and Positive tracking states may be enough, at least, for example, in cases where the state has a short period of time ago been Tracking.

According to an embodiment the tracking state of the tracking apparatus TA reaching the level of tracking accuracy capable of tracking a point and/or spot of any kind in the worksite coordinate system WCS accurately may be determined by at least one of: a) acquiring data by tracking at least three reference points RP with respect to the tracking apparatus TA; b) acquiring data by tracking one to two reference points RP with respect to the tracking apparatus TA in addition to acquiring data relating to an inclination of the tracking apparatus TA, and c) acquiring data by determining locations of at least four satellites with respect to the tracking apparatus TA.

According to an embodiment the tracking state of the tracking apparatus TA reaching the level of tracking accuracy capable of tracking a point and/or spot of any kind in the worksite coordinate system WCS accurately may thus be determined by acquiring data by tracking at least three reference points RP with respect to the tracking apparatus TA. These reference points may not lie on one line observed in three dimensions. The farther the reference points RP are from one line in three-dimensional space, the better the accuracy is to be achieved. If the tracking apparatus TA does not comprise any sensors STA for determining an inclination of the tracking apparatus TA, at least three reference points RP that does not lie on one line in three-dimensional space are needed so that the necessary data is available for reaching the level of capable of tracking the machine in the worksite coordinate system. As discussed above, the state could be named as Tracking.

In addition to or alternatively to the acquiring data by tracking at least three reference points RP with respect to the tracking apparatus TA, the tracking state of the tracking apparatus TA reaching the level of tracking accuracy capable of tracking a point and/or spot of any kind in the worksite coordinate system WCS accurately may be determined by acquiring data by tracking two reference points RP with respect to the tracking apparatus TA in addition to acquiring data relating to at least one of: the inclination of the tracking apparatus TA and the direction to North from the tracking apparatus TA. So, in this embodiment, the inclination information of the tracking apparatus TA and/or the direction to North from the tracking apparatus TA is acquired by some means as described for example above, whereby the tracking of only two reference points RP is enough for determining the tracking state of the tracking apparatus TA reaching the level of capable of tracking the machine in the worksite coordinate system WCS.

It should be noted that in cases where inclination of the tracking apparatus TA is used with tracking two reference points RP, the reference points may not reside one above the other, or parallel, with respect to the gravitational field of the earth—if they are, direction to North remains unsolved. Thus, in this case, the farther (measured in angle) the reference points are from being one above the other, or the more perpendicular, the better the accuracy achieved.

Further, it should be noted that in cases where direction to North from the tracking apparatus TA is used with tracking two reference points RP, the reference points may not reside at the same height from the earth, meaning at the same level with respect to the gravitational field of the earth -if they are, inclination of the tracking apparatus TA remains unsolved. Thus, in this case, the farther (measured in angle) the reference points RP are from being at the same height from the earth, meaning at the same level, or the more parallel, with respect to the gravitational field of the earth the better the accuracy achieved.

In addition to or alternatively to the acquiring data by tracking at least three reference points RP with respect to the tracking apparatus TA and/or the acquiring data by tracking two reference points RP with respect to the tracking apparatus TA in addition to acquiring data relating to at least one of: the inclination of the tracking apparatus TA and the direction to North from the tracking apparatus TA, the tracking state of the tracking apparatus TA reaching the level of tracking accuracy capable of tracking a point and/or spot of any kind in the worksite coordinate system WCS accurately may be determined by acquiring data by tracking one reference point RP with respect to the tracking apparatus TA in addition to acquiring data relating to an inclination of the tracking apparatus and acquiring data relating to a direction to North from the tracking apparatus. Thus, in this embodiment, the inclination information of the tracking apparatus TA and the direction to North from the tracking apparatus TA is acquired by some means as described for example above, whereby the tracking of only one reference point RP is enough for determining the tracking state of the tracking apparatus TA reaching the level of capable of tracking the machine in the worksite coordinate system WCS.

In addition to or alternatively to the acquiring data by tracking at least three reference points RP with respect to the tracking apparatus TA and/or the acquiring data by tracking two reference points RP with respect to the tracking apparatus TA in addition to acquiring data relating to at least one of: the inclination of the tracking apparatus TA and the direction to North from the tracking apparatus TA and/or the acquiring data by tracking one reference point RP with respect to the tracking apparatus TA in addition to acquiring data relating to an inclination of the tracking apparatus and acquiring data relating to a direction to North from the tracking apparatus, the tracking state of the tracking apparatus TA reaching the level of tracking accuracy capable of tracking a point and/or spot of any kind in the work site coordinate system WCS accurately may be determined by acquiring data by determining locations of at least four satellites with respect to the tracking apparatus TA. In this embodiment the at least two antennas 12 in the tracking apparatus TA determine the location of the at least four satellites with respect to the tracking apparatus TA. FIG. 7 shows schematically, on the right, a tracking apparatus TA with two antennas 12. With less than four satellites the acquired data does not provide accurate information unless the tracking apparatus TA comprises more than two antennas 12. In this embodiment, instead of equipping all the machines in the worksite with at least two antennas 12 the tracking apparatus TA may be equipped with at least two antennas 12. Further, regarding to this embodiment, according to which the tracking apparatus TA is equipped with at least two antennas 12, at least one of the at least two antennas 12 may reside in the worksite 13. In this embodiment the antenna 12 residing in the worksite 13 needs to be located optically with respect to the tracking apparatus TA by using, for example, at least one of the tracking devices TD of the tracking apparatus TA.

According to the above stated embodiments regarding the tracking apparatus TA to reach the level of capable of tracking the machine in the worksite coordinate system WCS, i.e. the Tracking-state, after the level is reached, the level may remain although the minimum requirements are not fulfilled in every time instant if the tracking apparatus TA is able to determine that it has remained it's stability. Similarly, according to the above stated embodiments it is possible to detect if the tracking state changes or if the tracking state is in the Pending-state or Out-state.

According to an embodiment, acquiring data by tracking locations of the one or more reference points RP with respect to the tracking apparatus TA is accompanied by identifying the initial locations of the one or more reference points RP by semi-automatically and/or automatically.

When the initial locations of the one or more reference points RP are identified semi-automatically, the operator 10 finds the at least one reference point

RP at the worksite 13 and guides the tracking apparatus TA to focus to the at least one reference point RP. Alternatively, the operator 10 may direct the tracking apparatus TA towards the area comprising the at least one reference point RP and the tracking apparatus TA itself identifies the at least one reference point RP at the worksite 13 and focuses to the at least one reference point RP. The operator 10 may for example select the at least one reference point RP in a menu or a database of the reference points RP to be the specific at least one identified reference point RP or the positioning system PS itself identifies the at least one reference point RP in the menu or the database of the reference points RP. The menu or the database of the reference points RP may for example be retrieved from a cloud service into the control unit 11 of the excavator 1, whereby they are retrievable from the excavator 1 by the at least one position determination unit PDU.

When the initial locations of the one or more reference points RP are identified automatically, the tracking apparatus TA itself identifies a necessary number of the reference points RP at the worksite 13 and allocates them with the information in a database comprising worksite information.

The identification of the initial locations of the one or more reference points RP by semi-automatically and/or automatically may be controlled by the control unit 11 of the excavator 1 and/or by the tracking apparatus TA and/or by the position determination unit PDU. The identification of the initial locations of the one or more reference points RP is done in order to individualize the reference points RP to the position determination unit PDU and retrieve the location information regarding each identified reference point RP so that the position determination unit PDU can operate correctly. The location information regarding each reference point RP in the worksite 13 may be input using a wireless or wired I/O device and/or may be retrievable from any known location such as worksite computer, cloud service and/or any computer or memory medium reachable by any wired or wireless network.

According to an embodiment, the tracking apparatus TA further determines a location and an orientation of the tracking apparatus TA itself based on the acquired data, and that the acquired data transmitted from the tracking apparatus TA to the at least one position determination unit PDU comprises at least location and orientation data of the tracking apparatus TA, tracking data regarding at least three marker points MP and data wherefrom the tracking state of the tracking apparatus TA may be determined. The tracking apparatus TA may be able to determine the location and orientation thereof for example with the sensors disclosed above. The position determination unit PDU thereafter determines the location and orientation of the machine based on the acquired data transmitted to the position determination unit PDU from the tracking apparatus. This embodiment is suitable to be used with machines that do not comprise any sensors or comprises only a few sensors regarding determining position and orientation of the machine therein but, however, comprises the position determination unit PDU. Based on the features disclosed herein the machine and especially the position determination unit PDU therein receives sufficiently data to be able to determine the location and orientation of the machine and the accuracy of the determined location and orientation. According to this embodiment the tracking apparatus TA determines beforehand its own position so that it does not need to be momentarily aware about the data based on which the location and orientation thereof is determined. Further, according to this embodiment the tracking apparatus TA may be used as a temporary reference point to other tracking apparatuses TA. In this case, the temporary reference point should by some generally known means indicate when it may be used as a temporary reference point. Accordingly, tracking apparatus may comprise respective temporary reference marker comprising at least one temporary reference point and the location information should thus be available likewise is available the location information regarding each reference point RP disclosed above.

According to an embodiment the position determination unit PDU further determines a level of accuracy of the determined location and orientation of the machine, and based on the determined level of accuracy, the machine provides at least one of the following options: a) enables the operation modes that may be selected at the current level of accuracy, b) indicates an operator if the current level of accuracy is below and/or falling below threshold level regarding the operation mode of the machine selected; and c) disables operation modes that need more accurate location and orientation of the machine. According to this embodiment the operation modes of the machine, i.e. the work tasks of the machine, may be classified based on the accuracy of the location and orientation of the machine needed to carry out the specific work task with the machine. If the present location or orientation accuracy of the machine is not high enough for carrying out a specific work task, the machine is prevented to carry out that specific work task until the location and orientation accuracy is high enough or at least the operator may be informed that the specific work task may not be recorded and/or considered as done since the location and orientation accuracy is not above threshold level required in this work task. The location accuracy is considered to be the higher the more there are acquired reference point RP and marker point MP data, the newer the data are and the more versatile the acquired data are. The location accuracy depends, as well, on how near from each other the reference points RP and the marker points MP whose data is acquired are from each other and which are the location of these reference points RP and marker points MP with respect to each other and what sensor information is additionally available, such as inclination and/or direction to North as disclosed above.

The acquired reference point RP and marker point MP data are versatile if there are location and orientation data about reference points RP and marker points MP being both substantially close to the tracking apparatus TA and substantially far away from the tracking apparatus TA. In addition to the information containing the reference point RP and marker point MP data, the positioning accuracy may depend on possible information regarding to stability and inclination of the machine as received from machine and the sensors therein.

According to an embodiment of the positioning system PS, at least one tracking apparatus TA comprises at least one tachymeter, and at least one marker point MP is a prism or a tag that can be detected by the tachymeter. Furthermore, according to this embodiment the machine comprises at least one gyroscope and/or at least one acceleration sensor in known position with respect to the at least one marker point MP, and the at least one position determination unit PDU further comprises receiving means for receiving data relating to the position of the at least one gyroscope and/or the at least one acceleration sensor with respect to the at least one marker point MP and for receiving data from the at least one gyroscope and/or the at least one acceleration sensor. The gyroscope in the machine provides information about the orientation changes of the machine and in some circumstances a direction to North, the gyroscope being able to learn for example the orientation of the upper carriage 2b the excavator 1 by a few revolutions of the upper carriage 2b relative to the under carriage 2ahe acceleration sensor in the machine provides information about the direction of gravitational field of the earth, thus, information regarding the inclination of the machine. In this embodiment there are thus available also data from the gyroscope and/or the acceleration sensor, which data may be utilized to define changes in location and orientation of the machine between operation cycles of the tachymeter.

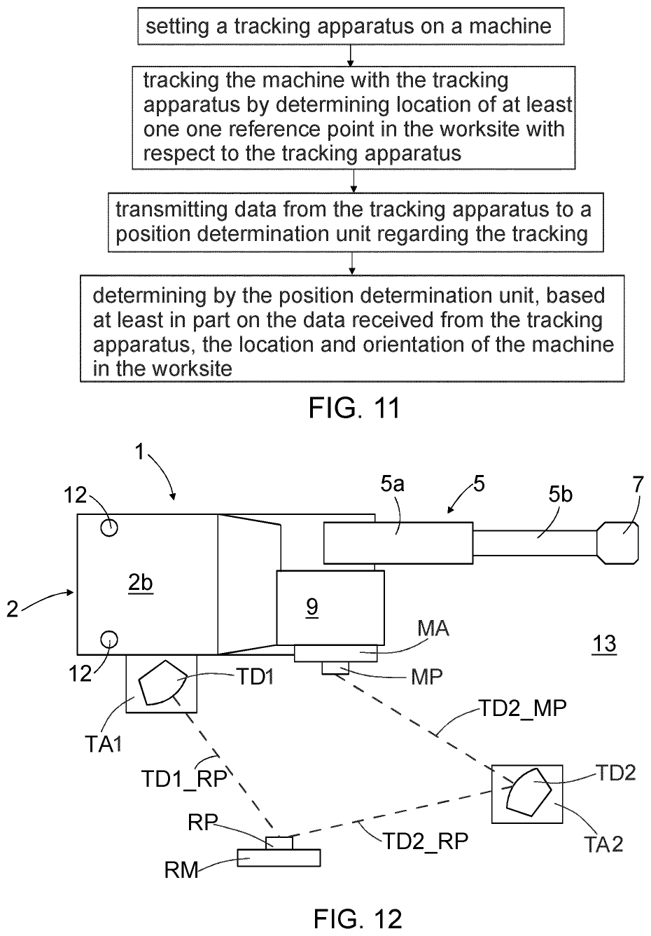

According an embodiment of a method for determining location and orientation of a machine in a worksite 13, the worksite 13 is equipped with at least one reference point RP, and the method comprises setting a tracking apparatus TA on the machine, tracking the machine with the tracking apparatus TA by determining location of at least one reference point RP in the worksite 13 with respect to the tracking apparatus TA, transmitting data from the tracking apparatus TA to a position determination unit PDU regarding the tracking, and determining by the position determination unit PDU based at least in part on the data received from the tracking apparatus TA the location and orientation of the machine in the worksite 13. According to this embodiment the machine itself, such as the excavator 1, is provided with the tracking apparatus TA that is arranged to track the machine by determining location of at least one reference point RP in the worksite 13 with respect to the tracking apparatus TA. FIG. 10 shows schematically an upper view of a worksite 13 with a machine provided with the tracking apparatus TA, whereby there is a visual connection TD_RP between a tracking device TD of the tracking apparatus TA and the reference point RP at a reference marker RM. FIG. 11 shows schematically the method according to this embodiment for determining location and orientation of the machine in the worksite 13. In this embodiment marker points MP intended to be set to the machine may be omitted or one or more marker points MP known in the machine coordinate system MCS may be used in verifying that the tracking apparatus TA re-attached to the machine resides at the same position and orientation as when previously attached, thus, making it possible to detach the tracking apparatus TA after day's work.

According to an embodiment the tracking device TD may be a lidar, which may be a mechanical lidar or a solid state lidar. Because of narrower field of vision of the solid state lidar when compared to the mechanical lidar the number of the solid state lidars required for a specific application may be higher than that of the mechanical lidars. However, the possible higher number of the solid state lidars required is to be compensated by a remarkable smaller price thereof when compared to prices of mechanical lidars.

If the tracking device TD is a lidar, the respective reference point RP is selected such that the lidar is able to detect the reference point RP. The reference point RP may for example comprise a number of balls, i.e. one or more balls. If a single reference marker RM comprises a single ball as a reference point RP, different reference markers RM at the worksite 13 may comprise a ball of different size in respect of the other reference markers RM, each reference marker RM and the corresponding reference point RP being thereby unique in respect of the other reference markers RM and the respective reference points RP therein. The diameters of the balls forming the respective reference points RP may for example be selected to be 5 cm, 10 cm, 15 cm, . . . , or 2 cm, 4 cm, 6 cm, 8 cm, . . . or 3 cm, 6 cm, 9 cm, 12 cm . . . etc. The sizes of the balls and their mutual diameter difference may be selected on the basis of actual distances between the tracking device(s) TD and the reference point(s) RP at the worksite 13.

According to an embodiment, if there are several reference markers and respective reference points RP at the worksite 13, each reference point RP may comprise a number of balls of same size but in different arrangements, or a number of balls of different size in same or different arrangements to make each reference point RP unique so that the reference points RP can be differentiated from the other reference points RP.

According to an embodiment, if there are several reference markers RM and respective reference points RP at the worksite 13, each reference point RP may comprise a number of balls of same size and, in addition to that, a number of balls, i.e. one or more, of different size to differentiate each reference point RP from the other reference points RP. Instead of one or more balls of different size, the reference points RP may be differentiated from each other by a code applied in the reference point. The code may for example be machine-readable by an appropriate sensor, or the code may be stored manually in an appropriate menu or database, whereby the location of the specific reference point RP at the worksite 13 may be determined based on the code. The codes of the reference points RP and the locations of the respective reference points RP may be instructed to the positioning system PS such that the positioning system PS is able to differentiate the reference points RP from each other with a substantially moderate level of accuracy even after the first successful positioning thereof, preventing a need for repositioning them after each change in the alignment thereof.

According to an embodiment of the method, wherein the machine is provided with the tracking apparatus TA, the method further comprises initializing a tracking state for the tracking apparatus TA by determining location and orientation of the tracking apparatus TA in a machine coordinate system MCS. According to this embodiment the tracking apparatus TA may be introduced by setting the tracking apparatus TA on the machine and allowing the tracking apparatus TA to check or verify its position relative to the machine.

According to an embodiment of the method, wherein the machine is provided with the tracking apparatus TA, the method further comprises indicating by the position determination unit PDU the current level of accuracy regarding the location and orientation of the machine achieved by the data received from the tracking apparatus TA. The level of accuracy regarding the location and orientation of the machine achieved by the data received from the tracking apparatus TA may cause, if the level of the accuracy is low, that work tasks requiring high level of accuracy is prevented to be carried out or carrying out is finished, as long as the level of accuracy is not high enough.

According to an embodiment of the method, wherein the machine is provided with the tracking apparatus TA, the method further comprises determining a level of accuracy regarding the location and orientation of the machine to be achieved, meaning above the minimum threshold level pre-determined, detecting by the position determination unit a need for higher level of accuracy regarding the location and orientation of the machine, and acquiring by the position determination unit an additional tracking data from the tracking apparatus. According to this embodiment the level of accuracy regarding the location and orientation of the machine to be achieved may be determined, for example, as a minimum threshold level, for example by a control unit of the machine, the position determination unit PDU or the building information modeling (BIM)—model residing, for example in cloud service or the worksite computer, on the basis of the specific work task to be carried out by the machine, or on the basis of the information provided by the operator. Thereafter the position determination unit PDU may detect the need for the higher level of accuracy regarding the location and orientation of the machine and acquire additional tracking data from the tracking apparatus TA. The additional tracking data may be acquired from the tracking apparatus TA semi-automatically and/or automatically.

The acquiring of the additional tracking data from the tracking apparatus TA semi-automatically comprises arranging the position determination unit PDU to provide at least one of: indicating the operator 10 the need for the tracking apparatus TA to detect at least one reference point RP, indicating the operator the need for the tracking apparatus TA to detect another reference point RP, and indicating the operator the need for the tracking apparatus TA to detect at least one further reference point RP, whereby the operator may operate the machine according to the indication. The acquiring of the additional tracking data from the tracking apparatus TA thus comprises retrieving information from the location and orientation of at least one reference point RP in a case where the tracking apparatus TA is not able to detect any reference point RP, or from the location and orientation of at least one additional reference point RP in a case where the reference points RP already tracked by the tracking apparatus TA are not able to provide sufficiently information to determine the location and orientation of the machine in the worksite 13 accurately enough.

According to an embodiment of the method for acquiring the additional tracking data from the tracking apparatus TA semi-automatically, the setting of the tracking apparatus TA on the machine comprises setting the tracking apparatus TA on the machine on an adjustable base B, whereby the operator 10 may operate the adjustable base B according to the indication received from the position determination unit PDU, and after each operating of the adjustable base B initializing of the tracking state for the tracking apparatus TA by determining location and orientation of the tracking apparatus TA in the machine coordinate system MCS occurs. According to this embodiment the operator 10 may adjust, by operating the adjustable base B, the tracking apparatus TA to find or localize the at least one reference point RP intended to be tracked by the tracking apparatus TA.

According to an embodiment of the method for acquiring the additional tracking data from the tracking apparatus TA automatically, the setting of the tracking apparatus TA on the machine comprises setting the tracking apparatus TA on the machine on an adjustable base B, and the additional tracking data from the tracking apparatus TA is acquired automatically by controlling the adjustable base B by at least one of the tracking apparatus TA and the position determination unit PDU. According to this embodiment, the at least one of the tracking apparatus TA and the position determination unit PDU is configured to adjust the adjustable base B such that the tracking apparatus TA finds or localizes the at least one reference point RP intended to be tracked by the tracking apparatus TA.

According to an embodiment of the method, wherein the machine is provided with the tracking apparatus TA, the method further comprises setting one or more additional tracking apparatuses TA to the worksite 13 and equipping the machine with at least one marker point MP known in the machine coordinate system MCS, acquiring data by the one or more additional tracking apparatuses TA by tracking reference point RP and marker point MP locations with respect to the respective one or more additional tracking apparatuses TA, transmitting the acquired data from the one or more additional tracking apparatuses TA to the at least one position determination unit PDU, and determining by the at least one position determination unit PDU based at least in part on the data received from at least one of: the tracking apparatus and the one or more additional tracking apparatuses, the location and orientation of the machine in the worksite coordinate system WCS. In other words, in this embodiment one or more additional tracking apparatuses TA are set at the worksite 13 and at least one marker point MP is set at the machine, the marker point MP intended to be tracked by the at least one additional tracking apparatus TA. FIG. 12 shows schematically an upper view of a worksite 13 with the machine provided with a first tracking apparatus TA1 and the worksite 13 provided with a second tracking apparatus TA2, whereby there is a visual connection TD1_RP between a first tracking device TD1 in the first tracking apparatus TA1 set on the machine and the reference point RP at a reference marker RM in the worksite 13 and visual connections TD2_MP between the second tracking device TD2 in the second tracking apparatus TA2 set in the worksite 13 and the marker MP at a marker MA set in the machine and TD2_RP between the second tracking device TD2 in the second tracking apparatus TA2 set in the worksite 13 and the reference point RP at the reference marker RM in the worksite 13.

According to an embodiment of the method comprising one or more additional tracking apparatuses TA, determining of the location and orientation of the tracking apparatus TA in the machine coordinate system MCS may be determined using one of the additional tracking apparatuses TA. According to this embodiment determining of the location and orientation of the tracking apparatus TA, that is set in the machine, may be determined in the machine coordinate system MCS using one of the additional tracking apparatuses TA.

It has been presented above some applications for determining especially the location and orientation of the machine in the worksite 13. In order to acquire worthwhile knowledge about the condition or state of the worksite 13, either close to the work machine or farther away from the work machine, such as at an area of a part of the worksite 13 or at a whole area of the worksite, additional measures may be combined with the determination of the location and orientation of the machine in the worksite 13 so as to determine the situational awareness in the worksite 13. The situational awareness in the worksite 13 is knowledge of the location and orientation of the work machine in the worksite 13, knowledge of location and orientation of any other work machines, knowledge of materials, tools, people, animals or any objects residing and/or moving in the worksite as well as knowledge of a condition or state of the worksite 13. Without knowing the location and orientation of the work machine in the worksite 13 accurately, the equipment residing in the machine may not be able to determine current condition or state of the worksite or of the part thereof, and thereby the situational awareness in the worksite or in the part thereof. On the other hand, if the situational awareness regarding the condition or state of the worksite has been determined accurately, the machine may use that information to assist determining its own location and orientation accurately in the worksite. In the following embodiments it has been presented a solution for determining the situational awareness in the worksite 13, wherein the determination of the location and orientation of the machine in the worksite 13 may be used in controlling the machine by using also information describing knowledge of the current condition or state of the worksite 13. Also, determining location and orientation of the machine may be essential part of situational awareness for some other machine, object or person, since the data regarding the determined location and orientation of the machine may be available for the others as situational awareness.

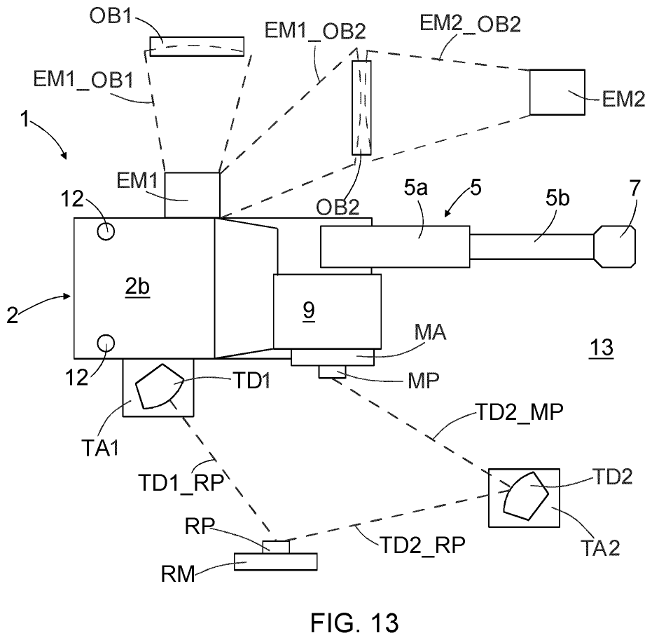

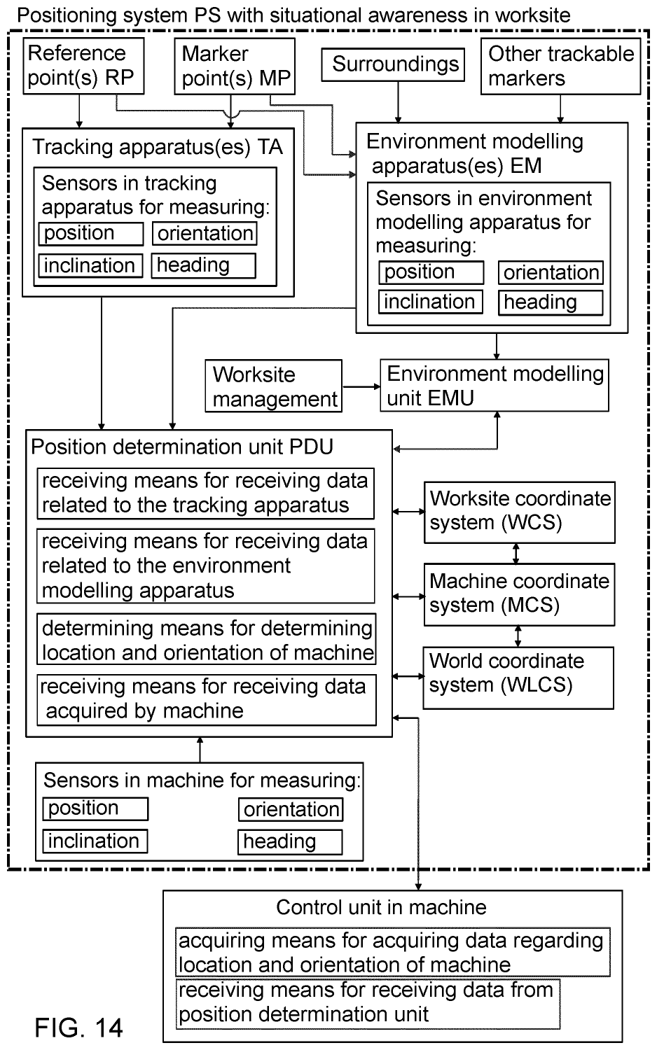

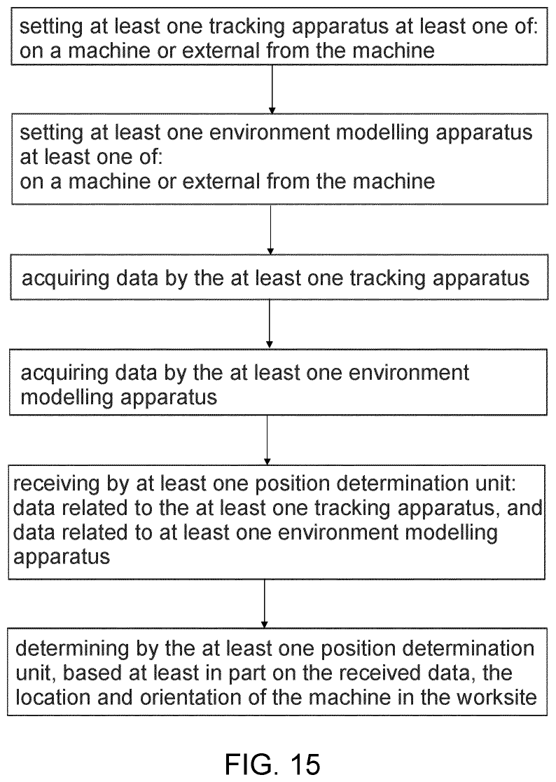

According to an embodiment of a method for determining situational awareness in a worksite 13, at least one environment modelling apparatus EM is set at least one of on a machine or external from the machine, i.e. on the machine and/or external from the machine. Furthermore, at least one tracking apparatus TA is set at least one of on the machine or external from the machine, i.e. on the machine and/or external from the machine. Thereafter it is acquired data by the at least one tracking apparatus TA and by the at least one environment modelling apparatus EM. Data related to the at least one tracking apparatus TA and data related to the at least one environment modelling apparatus EM is received by at least one position determination unit PDU. Based at least in part on the received data, the location and orientation of the machine in the worksite 13 is determined by the at least one position determination unit PDU. An embodiment like that is shown schematically in FIGS. 13, 14 and 15, wherein FIG. 13 shows schematically an upper view of a fourth worksite 13, FIG. 14 shows schematically some components of a positioning system PS for also determining situational awareness in the worksite 13 and FIG. 15 shows schematically some steps of the method for determining the situational awareness in the worksite 13. It should be noted that data related to at least one tracking apparatus and/or at least one environment modelling apparatus may be used by one or more position determination unit PDU of one or more machines, whereby the at least one tracking apparatus and/or the at least one environment modelling apparatus arranged in one machine may be exploited or utilized by at least one another machine.

FIG. 13 shows schematically an upper view of a fourth worksite 13 with a machine, that being an excavator 1 and being provided with a first tracking apparatus TA1, and the worksite 13 being provided with a second tracking apparatus TA2 such that there is a visual connection TD1_RP between a first tracking device TD1 in the first tracking apparatus TA1 set on the machine and a reference point RP at a reference marker RM set in the worksite 13, and a visual connection TD2_MP between the second tracking device TD2 in the second tracking apparatus TA2 set in the worksite 13 and a marker point MP at a marker MA set in the machine, as well as a visual connection TD2_RP between the second tracking device TD2 in the second tracking apparatus TA2 set in the worksite 13 and the reference point RP at the reference marker RM set in the worksite 13. The first tracking apparatus TA1 represents the tracking apparatus set on the machine and the second tracking apparatus TA2 represents the tracking apparatus set external from the machine. In the embodiment of FIG. 13 the second tracking apparatus TA2 is set in the worksite 13 but the second tracking apparatus TA2 could also be set on another machine and thereby possibly being also movable in the worksite 13. In the embodiment of FIG. 13, the tracking apparatuses TA1, TA2 are arranged to acquire data for the determination of the location and orientation of the machine in the worksite 13. According to an embodiment, also only one of the tracking apparatuses TA1, TA2 could be available.

The embodiment of FIG. 13 comprises also a number of environment modelling apparatuses EM. To be more specific, there is a first environment modelling apparatus EM1 and a second environment modelling apparatus EM2. The first environment modelling apparatus EM1 is set on the machine. The second environment modelling apparatus EM2 is external from the machine, set in the worksite 13, but the second environment modelling apparatus EM2 could also be set on another machine and thereby possibly being also movable in the worksite 13. According to an embodiment, also only one of the environment modelling apparatuses EM1, EM2 could be available. The environment modelling apparatuses EM1, EM2 are arranged to acquire data relating to the worksite 13 or a part thereof. This data may at least partly be used for the determination of the location and orientation of the machine or any other machine in the worksite 13.

In the example of FIG. 13 the first environment modelling apparatus EM1 is arranged to acquire data relating to a first object OB1 in the worksite 13 through a first data acquisition connection EM1_OB1 between the first environment modelling apparatus EM1 and the first object OB1. The first environment modelling apparatus EM1 is also arranged to acquire data relating to a second object OB2 in the worksite 13 through a second data acquisition connection EM1_OB2 between the first environment modelling apparatus EM1 and the second object OB2. The second environment modelling apparatus EM2 is also arranged to acquire data relating to the second object OB2 in the worksite 13 through a third data acquisition connection EM2_OB2 between the second environment modelling apparatus EM2 and the second object OB2. The respective data acquisition connections are shown in FIG. 13 schematically with conoidic forms. The data acquired by the at least one environment modelling apparatus EM1, EM2 is used for providing a model of the worksite 13 depicting a current or present state of the worksite 13 or a part thereof. The model may be a georeferenced spatial data model, or later mentioned also as the model, where is available the data that describes current or present state of the worksite 13.

According to an embodiment, depending on the actual device providing the data acquisition, the at least one tracking apparatus TA and the at least one environment modelling apparatus EM may be the one and same device, such as a stereocamera, in cases where the at least one reference point and/or the at least one marker point may be tracked and/or surrounding areas as spatial data of or relating to the worksite may be detected with the same device. Tracking reference points and/or marker points may be carried out simultaneously and/or at different times with detecting surrounding areas as spatial data of or relating to the work and saving to the model the parts of the detected spatial data deemed to be saved.

The environment modelling apparatus EM1, EM2 may comprise, as a modelling or tracking device, a camera, a stereocamera, a lidar, a radar or a tachymeter, for example. Therefore, the data acquisition connection between the environment modelling apparatus and the respective object, as provided by the environment modelling apparatus, may be visual or nonvisual. In combination with the environment modelling apparatus, also an inertial measurement unit comprising for example at least one of an accelerometer, a gyroscope or a magnetometer, or some other sensor disclosed above, may be applied for determining for example angular rate(s) and/or orientation of the environment modelling apparatus and/or forces affecting thereto for maintaining or improving the determination of the location and orientation of the machine, for example, in case of the determination of the location and orientation of the machine by using data acquired by at least one tracking apparatus TA and/or by at least one environment modelling apparatus EM being prevented or considered unreliable or for providing additional information useful, for example, for determining intended and/or unintended movement of the machine. Further, the environment modelling apparatus EM either comprises or is connected to means, such as an input-output unit, allowing receiving and/or sending information.

The first object OB1 and the second object OB2 are objects in the worksite 13 that may affect or that may be taken into account when controlling the operation of the machine. Therefore, they may be objects that may only have some impact on the control of the machine or objects to which it may actively be affected by the operations to be carried out by the machine. The objects OB1, OB2 may lie in the worksite 13 at the part of the worksite 13 wherein the active work to be carried out by the machine is going to take place. Alternatively, at least one of the objects OB1, OB2 may lie in the worksite 13 outside the part of the worksite 13 wherein the active work to be carried out by the machine is going to take place but still at such a part which may have some indirect impact on the work to be carried out by the machine and/or which may be indirectly affected to by the work carried out by the machine at that part of the worksite 13 at which the active work by the machine is going to take place. The object may therefore be an object that is a fixed permanent object, such as a rock, a rock mass or a building which is intended to be left in place in the worksite 13, or to be removed from the worksite 13, or an object under construction therein, or just a surface profile of a ground. Alternatively, the object may be an object that is only temporarily set at some place in the worksite 13 but will later be removed to another location, such as material to be used in the construction work in question. The object may also be an object that forms part of the positioning system PS for the machine, such as a reference marker RM or marker MA to be tracked by either the at least one tracking apparatus and/or the at least one environment modelling apparatus. There may be any number of these objects to be monitored or tracked in the worksite 13. For the determination of the situational awareness, the current or present state of these objects and the progress thereof may be modelled by the equipment or apparatuses providing the environment modelling.

FIG. 14 shows schematically an embodiment of the positioning system PS applied in the embodiment of FIGS. 13 and 15. The positioning system PS applied herein is substantially similar to that shown in FIG. 3 but additionally comprises components relating to the determination of the situational awareness, such as the environment modelling apparatus(es) EM and an environment modelling unit EMU providing a central unit for a number of the environment modelling apparatuses EM.

The at least one tracking apparatus TA is arranged to acquire data relating especially to the determination of the location and orientation of the machine in the worksite 13. The data related to the at least one tracking apparatus TA is received in the position determination unit PDU by receiving means for receiving data related to the at least one tracking apparatus. The data related to the at least one tracking apparatus TA may comprise for example data acquired by the tracking apparatus TA as well as data relating to inclination and/or heading and/or location information of the respective at least one tracking apparatus TA itself, which data may be utilized by the machine for determining its own location and/or orientation. The data related to the at least one tracking apparatus is considered in more detail later in this description.

The data related to the at least one environment modelling apparatus EM, which is also considered in more detail later in this description, may comprise data acquired by the at least one environment modelling apparatus EM and/or inclination and/or heading and/or location information of the respective at least one environment modelling apparatus EM itself and/or available earlier data regarding the worksite. The available earlier data regarding the worksite may be, for example, the building information model (BIM-model) or a spatial data of or relating to the worksite or a combination of the previous. The spatial data of or relating to the worksite or georeferenced spatial data may be, for example, data that describes current or present state of the worksite or a part thereon or more generally data with implicit or explicit reference to a location relative to at least one of: the worksite 13 or the Earth. Thus, such data may be, for example, data regarding a truck bringing crushed rock to the worksite by sharing to the model its location or time of arrival at the worksite and thus sharing the data may affect how the operator of an excavator plans to use his/her working time in the following minutes or hours. Further, shared and regarded as spatial data relating to the worksite may also be additional information regarding the crushed rock, for example, its colour, total weight of the load, humidity, temperature, etc.

The current or present state of the worksite may comprise at least information regarding work phases, operation or stage of various areas in the worksite, wherein the worksite may have been divided into as small areas as necessary, e.g. material pile may constitute one area having known work phase as well as additional information regarding the material pile. The current or present state of the worksite may further comprise information regarding objects and/or work machines in the worksite or associated with the worksite. For example, material pile ordered and arriving at some time at the worksite needs an area to be placed at the worksite. The current or present state of the worksite may further comprise personnel working in the worksite and each person may be associated with location data.

The georeferenced spatial data may form for example a database, a data structure and/or a model. Or georeferenced spatial data may be formed and/or organized and/or structured to a database with a certain data structure and/or model. The model refers to a georeferenced spatial data model, later being referred to also as the model. The model may be, for example, like the BIM-models are. The database, data structure and/or the model is designed for the interactions with applications and/or users and is accessed by authorized users and/or authorized operators and/or authorized systems and/or authorized applications. The data may be acquired from a number of tracking apparatuses, environment modelling apparatuses, surveying devices commonly used in worksites, for example, and it may comprise, for example, reference points RP of the worksite, marker points of the machines operating in or associated with the worksite or any other trackable marker attached to at least one of: machine, obstacle, object or equipment of a person working on the worksite. Identification data regarding reference points RP, marker points MP and any other trackable markers may be available to operators via the database, the data structure or the model. The data related to the at least one environment modelling apparatus EM is received in the position determination unit PDU by receiving means for receiving data related to the at least one environment modelling apparatus EM. The position determination unit PDU is configured to determine the location and orientation of the machine in the worksite 13 based at least in part on the data received, i.e. related to the at least one tracking apparatus TA and the at least one environment modelling apparatus EM. In addition to the data received, i.e. the data that relates to tracking apparatuses and environment modelling apparatuses, the position determination unit PDU may also receive data from the machine by receiving means for receiving data acquired by the machine, which data may be taken into account when the position determination unit PDU determines the location and orientation of the machine in the worksite 13.

The solution above provides the determination of the location and orientation of the machine in the worksite. It means that after the location and orientation is determined in the worksite the machine may provide its location and orientation information as georeferenced spatial data for other operators, for example other tracking apparatuses and/or environment modelling apparatuses, in the worksite 13 to be used as situational awareness information when acquiring data. On the other hand, after the location and orientation of the machine in the worksite is determined, the machine itself is aware of its location and orientation within the georeferenced spatial data and thus it may observe its surroundings in the georeferenced spatial data model as well as carry out work tasks according to the BIM-model and update the georeferenced spatial data model regarding the work tasks carried out as well as observe the locations and orientations of the machines that have provided their location and orientation information to the georeferenced spatial data model, or the model. As an initial data for starting the procedure for determining the location and orientation of the machine and thereafter providing situational awareness in the worksite 13 for itself and to other operators as well as the model, depending on the system installation of the machine, e.g. amount of sensors etc., a location and orientation of at least one reference point RP detected by the tracking apparatus TA, is needed or it may detect by an environment modelling apparatus EM such georeferenced spatial data that is marked or confirmed to be accurate enough to enable determining location and orientation of the machine in the worksite 13. Thereafter the determination of the location and orientation in the BIM-model of the worksite 13 may be carried out and situational awareness regarding the machine may be provided to the model as usable for the other operators as well as for updating the model and/or the BIM-model regarding the work tasks carried out. Although the machine is typically located in the worksite in the part thereof at which the active work is going to take place, there may be occasions at which at least a part of the machine may reach out outside of that part in the worksite, for example for reaching for a material to be used in a construction work. In response to the utilization of the at least one tracking apparatus TA and the at least one environment modelling apparatus EM the determination of the location and orientation of the machine in the worksite can be carried out also during occasions of that kind. It should be noted that the location and orientation of the machine may often be determined accurately enough although not both the tracking apparatus TA and the environment modelling apparatus EM are able to acquire valuable data regarding determining the location and orientation of the machine. Mostly, there is sufficient combination of data from the sensors of the machine, data from the sensors of the at least one tracking apparatus TA, data from the sensors of the at least one environment modelling apparatus EM, the data acquired by the at least one tracking apparatus TA and the data acquired by the at least one environment modelling apparatus EM to result in accurate enough determination of the location and orientation of the machine. The number of different combinations enables, for example, the passing person walking or standing in front of the at least one tracking apparatus TA or the at least one environment modelling apparatus EM not to fail the determination of the location and orientation of the machine in the worksite and thus interrupting a work task requiring accurate location and orientation of the machine or failing to determine the situational awareness regarding the machine in the worksite. Furthermore, by the utilization of the at least one environment modelling apparatus EM it may also be acquired data how it is possibly affected, in response to the work carried out by the machine in the part of the worksite at which the active work is going to take place, also to objects in the surroundings, whereby also various kind of negative influences, such as downcast faults, taking place in the worksite 13 may be detected. The solution is applicable for all operating situations of the machine, i.e. for machines that are substantially stationary when carrying out the work, for machines working at the same location without substantially moving from one location to another and for machines actively or substantially actively moving from one location to another.

According to an embodiment, a direction of travel or an alternative direction of travel of the machine in the worksite 13 is determined by the at least one position determination unit PDU based at least in part on the received data. The effect of this embodiment is that the exact direction of travel of the moving machine may be determined based on the data acquired by the at least one environment modelling apparatus EM and by the at least one tracking apparatus TA. In the event of the machine being an excavator, the excavator has two main directions to travel, both of them additionally together with or without turning a curve at the same time, all of these options being detectable based at least in part on the received data. Further effect of this embodiment is that the situational awareness data created by the machine may include information in the model regarding how quickly the machine could move to which direction. Thus, for example autonomous vehicle working nearby the machine would choose such a route past the machine that may not be interrupted by the machine. As well, a person not paying attention for example because he/she is standing his/her back against the machine may be informed or alarmed if he/she is in one of those sectors regarding the machine, which is one of those sectors where the machine could quickly move.

According to an embodiment, it is further determined at least one of an accuracy level or validity, i.e. an accuracy level and/or validity, of the determined location and orientation of the machine in the worksite 13.

It may be affected on the achievable accuracy level of the determined location and orientation of the machine in the worksite by a number of environment modelling apparatuses used, by a number of tracking apparatuses used as well as by a number of reference points and marker points used and by the area of detected surroundings used as well as by the distances between the tracked locations and the apparatuses tracking, and also by other factors as indicated above in this description, such as by the stability of the tracking apparatus(es) TA. Also, current weather may affect to the achievable accuracy level, as well as apparatuses used as tracking apparatuses and/or environment modelling apparatuses. Further, the area where the surroundings are detected affects, since for example flat parking space contains much less suitable targets to track with environment modelling apparatus than for example a parking space having one or more large working tools (temporary) stored. In addition, the level of accuracy level may be the higher the better the error sources of the data acquired may be modelled.

On the validity of the determined location and orientation of the machine in the worksite it may be affected by acquiring the data by the at least one environment modelling apparatus and by the at least one tracking apparatus sufficient frequently, in case of the moving machine preferably substantially continuously, so that the determined location and orientation will not be based on very old data. In the event of the determined location and orientation of the machine being based on the data acquired by the tracking apparatus(es) TA and/or environment modelling apparatus(es) EM arranged in that specific machine or in the worksite, and the machine being additionally provided with sensors of its own, the validity of the data acquired by the respective apparatuses may be improved by the data provided by the sensors in the machine. This allows the carrying out of the work task to be continued in case of the determination of the location and orientation of the machine by using data acquired by at least one tracking apparatus TA and/or by at least one environment modelling apparatus EM being prevented or considered unreliable. In that case the data acquired by the apparatuses does not necessarily need to be very new. However, in the event of the determined location and orientation of the machine being based on the data acquired by tracking and/or environment modelling apparatuses arranged in another machine, the data acquired by the apparatuses in that another machine should be quite new, i.e. a timestamp of the acquired data should be quite new, preferably as new as possible, because the machine the location and orientation of which is to be determined is not typically able to verify or improve the validity of the acquired data because of not being able to detect any changes in the location or orientation of that another machine where the apparatuses for acquiring the data are attached to. On the other hand, the machine that may acquire data from apparatuses arranged in another machine may as well receive for example data related to these apparatuses that may indicate the accuracy and/or validity of the data.

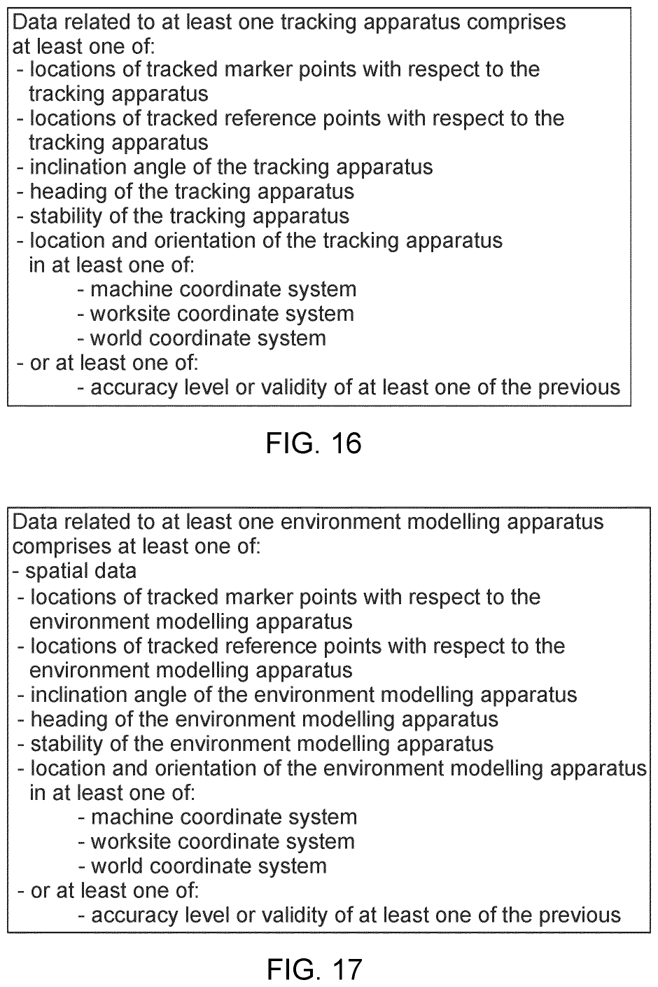

According to an embodiment, the data related to the at least one tracking apparatus TA comprises at least one of: locations of tracked marker points MP with respect to the tracking apparatus TA, locations of tracked reference points RP with respect to the tracking apparatus TA, inclination angle of the tracking apparatus TA, heading of the tracking apparatus TA, stability of the tracking apparatus TA, location and orientation of the tracking apparatus TA in at least one of: a machine coordinate system MCS, a worksite coordinate system WCS or a world coordinate system WLCS or at least one of: accuracy level or validity of at least one of the previous. FIG. 16 shows schematically the data related to the at least one tracking apparatus TA according to this embodiment. The data related to the at least one tracking apparatus TA may also comprise other information not specifically disclosed herein. Thereby the data related to the tracking apparatus TA may also comprise location and/or orientation data of the tracking apparatus TA itself, which data may be received without the operator knowing it and it may be utilized by the machine for determining its own location and/or orientation. As already shortly indicated above, the data in question herein may be provided by the apparatuses and/or sensors arranged, for example, in the same machine where each tracking apparatus TA is attached to, or the data in question herein may be provided by the apparatuses and/or sensors arranged, for example, in another machine than where each tracking apparatus TA is. Alternatively, the data in question herein may be provided by a combination of the previous such that if an apparatus or a sensor provides at least one piece of information it may be added as such to the data related to the tracking apparatus TA, or if another apparatus or a sensor provides another at least one piece of information it as well may be added as such to the data related to the tracking apparatus TA. Furthermore, if two or more apparatuses or sensors provide the same information, for example, inclination of the tracking apparatus TA, such two or more pieces of information may be either for example combined mathematically such as by averaging or weighted averaging or it may be selected which of the two or more pieces of information are added to the data related to the tracking apparatus TA, for example by selecting the one deemed more accurate and/or more valid.

The locations of the tracked marker points MP with respect to the tracking apparatus TA and the locations of the tracked reference points RP with respect to the tracking apparatus TA may be determined as disclosed above in connection with other embodiments in this description.

The inclination angle of the tracking apparatus TA, the heading of the tracking apparatus TA and the stability of the tracking apparatus TA may be determined by sensors arranged in the tracking apparatus TA as disclosed above in this description, or alternatively by the sensors arranged in the machine if the location and orientation of the tracking apparatus TA in the machine coordinate system MCS is known. The location and orientation of the tracking apparatus TA may be determined by three-dimensional coordinates and inclination and heading angles such as roll, pitch and yaw in the worksite coordinate system WCS and/or three-dimensional coordinates and inclination and heading angles such as roll, pitch and yaw in the machine coordinate system MCS as disclosed above. Alternatively, or in addition to that the location and orientation of the tracking apparatus TA may be determined by three-dimensional coordinates and inclination and heading angles such as roll, pitch and yaw in the world coordinate system WLCS, that being for example the satellite-based positioning system GNSS.

On the accuracy level or validity of the data related to the at least one tracking apparatus TA it may be affected to by a number of the tracking apparatuses used, by a number of reference points and marker points used as well as the distances between them and the tracking apparatuses and by other factors as indicated above, such as the stability of the tracking apparatus(es) TA and the sufficiently frequent acquirement of the data by the at least one tracking apparatus TA and possible sensors in the tracking apparatus(es) TA and/or in the machine.

According to an embodiment, the data related to the at least one environment modelling apparatus is at least one of: spatial data, locations of tracked marker points MP with respect to the environment modelling apparatus EM, locations of tracked reference points RP with respect to the environment modelling apparatus EM, inclination angle of the environment modelling apparatus EM, heading of the environment modelling apparatus EM, stability of the environment modelling apparatus EM, location and orientation of the environment modelling apparatus EM in at least one of: a machine coordinate system MCS, a worksite coordinate system WCS or a world coordinate system WLCS or at least one of: accuracy level or validity of at least one of the previous. FIG. 17 shows schematically the data related to the at least one environment modelling apparatus EM according to this embodiment. The data related to the at least one environment modelling apparatus EM may also comprise other information not specifically disclosed herein. Thereby the data related to the environment modelling apparatus EM may also comprise location and/or orientation data of the environment modelling apparatus EM itself, which data may be received without the operator knowing it and it may be utilized by the machine for determining its own location and/or orientation. As already shortly indicated above, the data in question herein may be provided by the apparatuses and/or sensors arranged, for example, in the same machine where each environment modelling apparatus is attached to, or the data in question herein may be provided by the apparatuses and/or sensors arranged, for example, in another machine than where the environment modelling apparatus EM is. Alternatively, the data in question herein may be provided by a combination of the previous such that if an apparatus or a sensor provides at least one piece of information it may be added as such to the data related to the environment modelling apparatus EM, or if another apparatus or a sensor provides another at least one piece of information it as well may be added as such to the data related to the environment modelling apparatus EM. Furthermore, if two or more apparatuses or sensors provide the same information, for example, inclination of the environment modelling apparatus EM, such two or more pieces of information may be either for example combined mathematically such as by averaging or weighted averaging or it may be selected which of the two or more pieces of information are added to the data related to the environment modelling apparatus EM, for example by selecting the one deemed more accurate and/or more valid.

The spatial data tracked and/or detected by the environment modelling apparatus EM may be raw data or pre-processed data, which data may concern on the whole worksite 13 or a specific part thereof. The spatial data, as discussed earlier in this description, comprises for example data related to the worksite 13 as a whole or data related to a specific part of the worksite 13 which part may be the same part at which the machine in question is actively going to be operated or another part of the worksite 13. The spatial data may comprise a surface profile of the worksite or the specific part thereof, permanent or temporary objects, such as housing buildings or storage rooms, rocks, rock masses, trees, work machines or auxiliary work machines, materials to be used in the worksite etc. or at some specific parts thereof. These objects may include visible and invisible objects, the invisible objects being for example underground pipes or power lines. The spatial data may also include environmental conditions of the worksite or the specific part thereof, such as temperature, humidity and depth of rainfall, for example an hourly or daily basis. The spatial data related to the worksite or the specific part thereof may also comprise other information which is related to the worksite or the specific part thereof and which can be detected by at least one apparatus available.

The locations of the tracked marker points MP with respect to the environment modelling apparatus EM and the locations of the tracked reference points RP with respect to the environment modelling apparatus EM may be determined in a similar way as the locations of the tracked marker points MP and the tracked reference points RP with respect to the tracking apparatus TA. The specification above in this description relating to the tracking apparatuses TA is in this respect applicable to the environment modelling apparatuses EM as well.

The inclination angle of the environment modelling apparatus EM, the heading of the environment modelling apparatus EM and the stability of the environment modelling apparatus EM may be determined by sensors arranged in the environment modelling apparatus EM. In this respect the specification and embodiments of FIG. 7 above relating to the tracking apparatuses TA and the sensors therein is also applicable to the environment modelling apparatuses EM. Alternatively the inclination angle of the environment modelling apparatus EM, the heading of the environment modelling apparatus EM and the stability of the environment modelling apparatus EM may be determined by sensors arranged in the machine if the location and orientation of the environment modelling apparatus EM in the machine coordinate system MCS is known.

Similarly to the tracking apparatuses TA above, the location and orientation of the environment modelling apparatus EM may be determined by three-dimensional coordinates and inclination and heading angles such as roll, pitch and yaw in the worksite coordinate system WCS and/or three-dimensional coordinates and inclination and heading angles such as roll, pitch and yaw in the machine coordinate system MCS. Alternatively, or in addition to that the location and orientation of the environment modelling apparatus EM may be determined by three-dimensional coordinates and inclination and heading angles such as roll, pitch and yaw in the world coordinate system WLCS.

The information relating to the environment modelling apparatus EM may be used in many ways to model the worksite 13 for determining the situational awareness in the worksite 13. Relating to a specific work task to be carried out the situational awareness obtained may for example include information about initial state of the worksite 13 or a part thereof before starting the work task as well as the final result after the specific work task has been carried out. Additionally, the situational awareness may include information about intermediate stages of the worksite 13 or a part thereof during carrying out the work task, as well as acquiring information relating to deviations appearing during the carrying out of the work task, such as information relating to objects having been originally unnoticeable but emerging or becoming visible during the carrying out of the work task, such as an underground rock or rock mass becoming visible during excavation work. The disclosed solution for the determination of the situational awareness allows the surveying or modelling of the object emerged already during carrying out of the present work task by the equipment provided, which, in turn, allows possible planning of the future work tasks for removing the rock or rock mass, for example.

On the accuracy level or validity of the data related to the at least one environment modelling apparatus EM it may be affected to by a number of the environment modelling apparatuses used, by a number of reference points and marker points used and by the area of detected surroundings as well as by the distances between these and the environment modelling apparatuses and by other factors as indicated above, such as the stability of the environment modelling apparatus(es) EM and the sufficiently frequent acquirement of the data by the at least one environment modelling apparatus EM and possible sensors in the environment modelling apparatus(es) EM and/or in the machine. The description above related to the accuracy level or validity of the data related to the at least one tracking apparatus TA is thus applicable also for the accuracy level or validity of the data related to the at least one environment modelling apparatus EM.

The accuracy of the data acquired by the at least one environment modelling apparatus EM, as well as the accuracy of the data acquired by the at least one tracking apparatus TA may also be increased by determining average information for the data acquired. This is an especially useful way in case of the at least one tracking apparatus TA and/or the at least one environment modelling apparatus EM being arranged in a machine that remains at one single location for a long period of time, whereby it may be determined an average information for several individual pieces of data information acquired at different time instants as long as the machine has remained at the same location during acquiring of the said individual pieces of data information.

The determination of the average information may also be applied in case of the at least one tracking apparatus TA and/or the at least one environment modelling apparatus EM being arranged in a moving machine as long as the at least one point or object to be tracked or monitored remains same during the acquiring of the said individual pieces of data information.

Also, a weighted average value may be applied for improving the accuracy of the acquired data. According to this embodiment data acquired by an apparatus remaining closer to an object to be monitored may have a higher weight than the data acquired by an apparatus remaining farther away from the object to be monitored. This can be used to improve especially the accuracy of the acquired data in case of a moving machine.

Accurate determination of the situational awareness may also require a correct synchronization of the determined location and orientation of the machine and the data modelling the worksite 13 or a part thereof and providing data relating to the situational awareness in the worksite 13. In case of the machine remaining at one single location for a long period of time the very exact synchronization is not so important for the accurate determination of the situational awareness because the machine is not moving. However, in case of moving machines the importance of the synchronization increases for a correct compliance between the determined location and orientation of the machine and the data modelling the worksite 13 or a part thereof. Therefore, especially for the moving machines the acquiring of the data needed may take place even in periods of time of milliseconds for the correct synchronization between the determined location and orientation of the machine and the data modelling the worksite 13 or a part thereof. In this case, too, there is no ultimate requirement relating to the real time between the data acquisition for the determination of the location and orientation of the machine and for the modelling the worksite 13 or a part thereof as long as they can be synchronized with each other.

In the event of the at least one tracking apparatus TA and the at least one environment modelling apparatus EM being the one and same equipment the acquired data determining the location and orientation of the machine and the acquired data modelling the worksite 13 are automatically synchronous.

According to an embodiment, the spatial data comprises at least one of: pictorial data, point cloud data or data with implicit or explicit reference to a location relative to at least one of: the worksite 13 or the Earth. According to this embodiment the data describing the spatial data, especially the spatial data relating to physical objects in the worksite 13 may be represented by pictorial data, i.e. by utilizing pictures, and/or by point cloud data, whereby the physical objects may be described by point clouds. Despite of the content of a specific data item of the spatial data and the way of its representation, each specific data item may be combined with an implicit or explicit reference to a location relative to the worksite 13 or the Earth, that allowing the information of the specific data item to be assigned at a specific location in the worksite. Explicit reference may be for example to a location in the worksite coordinate system WCS or in the world coordinate system WLCS and implicit reference may be for example to a location of a point cloud seen by an environment modelling apparatus in the coordinate system of the environment modelling apparatus the location and orientation of which is known in either the worksite coordinate system WCS or in the world coordinate system WLCS.

According to an embodiment, the method further comprises receiving by at least one environment modelling unit EMU an indication of a material delivery, material delivery base determined by first data related to at least one environment modelling apparatus EM covering an area of material to be placed, and material delivery complete determined by second data related to at least one environment modelling apparatus EM covering the area of material to be placed, and saving by the at least one environment modelling unit EMU at least in part the data regarding the indication of the material delivery, the material delivery base and the material delivery complete as a material delivered. It should be noted that the first data and the second data may be determined by different at least one environment modelling apparatus EM.

The indication of the material delivery may comprise information or data of the actual delivery of the material, i.e. a date and time of the material delivery having taken place, and a product description of the delivered material. The indication of the material delivery may comprise, either as separate information or as part of the product description of the delivered material, other information relating to the content of the delivered material, such as type or grade of the delivered material and/or amount and/or weight and/or volume and/or colour of the delivered material.

In response to the material being intended to be delivered to an area in the worksite 13 or in a specific part therein, at least one environment modelling apparatus EM covering that area is configured to determine the material delivery base at the area at which the material to be delivered is going to be placed. In other words, according to this embodiment the at least one environment modelling apparatus EM is configured to determine for example a surface profile of that area of the worksite 13 at which the material to be delivered is going to be placed. This allows later, when the material delivered is moved to another place, for example when used for its end use, a control of a work machine such that substantially all the delivered material, but preferably not the material of the delivery base at all, will be removed away from the material delivery base at which the delivered material was placed, thus leaving the material delivery base substantially as it was before the material delivery. The information relating to the material delivery base provides first data related to at least one environment modelling apparatus EM covering the area of the material to be placed.

In response to the material having been delivered to the worksite 13, or to the specific part therein, at least one environment modelling apparatus EM covering that area is configured to determine information relating to the material delivery being complete, i.e. information describing the complete or finished material delivery, such as a pile of crushed stone. This for example allows a design of later working phases, such as a scheduling of a laying of the crushed stone for the control of a respective work machine. The information relating to the material delivery complete provides second data related to at least one environment modelling apparatus EM covering the area of the material to be placed.

least part of the data regarding the indication of the material delivery, the material delivery base and the material delivery complete is saved by at least one environment modelling unit EMU as material delivered describing the completed or finished delivery of the material and characteristics thereof.

According to an embodiment, the method further comprises receiving by the at least one environment modelling unit EMU one or more indications relating to a regional data of the worksite, i.e. data relating to an area of a part of the worksite and including information relating to for example work phase(s) and/or work stage(s) in the respective area of the part of the worksite. Additionally, the at least one environment modelling unit EMU receives data related to the at least one environment modelling apparatus EM, and by taking into account the one or more indications, it is derived from the data related to the at least one environment modelling apparatus EM a georeferenced spatial data of respective areas and saved at least in part the georeferenced spatial data to for example the model.

According to this embodiment, the at least one environment modelling unit EMU is configured to receive, for example from an application interface used by worksite management, one or more indications relating to the work phase(s) and/or work stage(s) of the respective areas of parts of the worksite 13. These indications may comprise information relating to the work phases or operations that have already been carried out or are presently being carried out in the worksite 13 or at a specific part thereof. Alternatively, or in addition to that, these indications may comprise information relating to the stage(s) of the worksite 13 or the specific part thereof, i.e. a level of the progress of the worksite 13 or the specific part thereof. The level of the progress of the work may be different at different parts of the worksite 13. Additionally, the at least one environment modelling unit EMU is configured to receive data related to the at least one environment modelling apparatus EM, the data related to the at least one environment modelling apparatus EM having been discussed in more detail above in this description.

Furthermore, the at least one environment modelling unit EMU is configured to take into account the one or more indications and to derive from the data related to the at least one environment modelling apparatus EM a georeferenced spatial data of the respective area(s) of the part(s) of the worksite 13 and to save at least in part the georeferenced spatial data to the model, or the georeferenced spatial data model. The at least one environment modelling unit EMU may comprise at least one memory unit to store at least temporarily the saved data, unless possible memory units in the position determination unit PDU are utilized. The data and/or the model may for example be saved to worksite computer and/or to a cloud service and/or any other memory, database or data structure suitable for storing the data and/or the model.

The georeferenced spatial data refers to the spatial data, which has been discussed as such in more detail above, but which spatial data is further combined with more specific or more exact location information determining or establishing the location of the items or objects of the spatial data in the worksite or in the specific part thereof. One important portion of the georeferenced spatial data is as-built data that describes the stage or level of progress of the work in the worksite or in the specific part thereof.

According to an embodiment, the step of saving at least in part the georeferenced spatial data further comprises determining, based at least in part on the data received from the at least one environment modelling apparatus, the areas the georeferenced spatial data of which is to be saved, and saving the georeferenced spatial data of the areas determined to be saved. An area of the georeferenced spatial data refers herein to an area in the worksite. If new georeferenced spatial data was taken from a parking space area of the worksite to be saved into the model and there was an additional excavator bucket stored in that area the point cloud describing the additional excavator bucket will not be saved as crushed stone level at that area whereas the area next to the bucket may be saved as point cloud describing the crushed stone level if it is known from the history of the area that the work phase has been as filling crushed stone to a level indicated in the BIM-model. Thus, according to this embodiment not all the georeferenced spatial data is to be saved but for example areas in the retrieved data that are for example in the operators own working area such as the part of a road bed the operator is working on. As well, the environment modelling unit EMU may have had an indication relating to an adjacent part of the road bed, where a colleague of the operator is working. The colleague or the worksite management may have interests on the georeferenced spatial data the operator collects regarding the part of the road bed the colleague is working on, thus the environment modelling apparatus of the operator may save also the part of the geospatial data that reaches to the adjacent part of the road bed but probably not the area that goes beyond their combined working area of the road bed. As well, such georeferenced spatial data may be also saved that relates to items or objects, that may have impact on the determination of the location and orientation of the work machine for advancing the progress of the worksite. Therefore, for example point clouds describing persons or vehicles remaining temporarily in the worksite will not necessarily be saved if they do not have any impact on the determination of the location and orientation of the work machine in view of the progress of the worksite. The selection of the data not to be saved may be provided or assisted by an operator of the machine or it may be completely automatic utilizing for example neural network applications. Other applications, such as machine control level applications for example for avoiding any collision between the work machine and said kind of temporary objects may be utilized in the control of the machine, if necessary. Detected temporary objects may be gathered into their own database or data structure, for example. As well, tools and/or materials located in the worksite or relating to the worksite may also be gathered into their own database or data structure, for example.

According to an embodiment, the step of determining, based at least in part on the data received from the at least one environment modelling apparatus, the areas of the georeferenced spatial data which are to be saved, comprises detecting the areas where the georeferenced spatial data of the at least one environment modelling apparatus is obstacle-free and regarding the obstacle-free areas. Furthermore, it is compared the current accuracy of the determined location and orientation of the machine in the worksite with the accuracy of the determined location and orientation of the machine in the worksite in time of the previously saved georeferenced spatial data, and whether the current accuracy is above about as good, it is updated the saved georeferenced spatial data in the obstacle-free areas. Updating data in this context comprises at least one of: replacing, rewriting, adjusting, adding or averaging the data using known mathematical method such as for example average or weighted average.

In this embodiment, it is determined obstacle-free areas in the georeferenced spatial data provided by the at least one environment modelling apparatus EM, i.e. areas that provides information about the actual stage of the worksite or a specific part thereof for example without any temporary obstacles appearing in the captured view of the at least one environment modelling apparatus EM. It is determined by the position determination unit PDU, regarding these obstacle-free areas in the georeferenced spatial data, the current or present location and orientation of the machine in the worksite 13 as well as the accuracy of the location and orientation of the machine. Furthermore, it is compared, by the position determination unit PDU, the accuracy relating to the current location and orientation of the machine in the worksite 13 with an accuracy of the location and orientation of the machine regarding a previously saved or stored georeferenced spatial data. In response to the accuracy relating to the current location and orientation of the machine being above almost as good, i.e. when taking into account a margin or an error in determining the accuracy and the accuracy being at least as good or even better than the accuracy of the location and orientation of the machine relating to the previously saved georeferenced spatial data, the saved georeferenced spatial data is updated, i.e., replaced, rewritten, adjusted, added or averaged using known mathematical method such as for example average or weighted average in the obstacle-free areas. In addition, when the accuracy criterion is fulfilled, it may further be determined a threshold level for each accuracy level to determine how the georeferenced spatial data should be updated in each case. Such threshold level might be for example error of margin in determined accuracy level. For example, if it is determined that the tool's real location in the worksite coordinate system is within 20 mm, the threshold might be 20 mm, 40 mm or even 80 mm. The use of the threshold ensures that very minor or negligible changes, i.e. changes below the threshold in an area of the georeferenced spatial data do not initiate rewriting or replacing of the previously saved georeferenced spatial data but may initiate, for example, averaging or weighted averaging the georeferenced spatial data with the previously saved georeferenced spatial data. If the changes are above the determined threshold the update may be replacing or rewriting the georeferenced spatial data, since in such case it should be assumed that changes have been made in the environment.

According to an embodiment, it is resolved, by the at least one position determination unit which determined the location and orientation of the machine in the worksite, data regarding at least one of: a tracking apparatus, an environment modelling apparatus, an object or another machine; and the data resolved is transmitted at least one of: as part of data related to the respective tracking apparatus, environment modelling apparatus, object or another machine, or as data receivable by at least one position determination unit.

According to this embodiment, the at least one position determination unit PDU which determined the location and orientation of the machine in the worksite 13 may resolve, i.e. determine, for example in connection with its own measures data relating to for example at least one of a tracking apparatus TA, an environment modelling apparatus EM, an object or another machine. The object may be an object to be avoided, such as an obstacle, or an object to be approached or of interest, such as material to be used in the work. After this resolving the data resolved is transmitted for example to a worksite computer and/or to a cloud service and/or memory, database or data structure suitable for saving the data at least one of: as part of data related to the respective tracking apparatus TA, environment modelling apparatus EM, object or another machine, and/or as data receivable by at least one position determination unit PDU. The accuracy and/or validity regarding this kind of data resolved depends on the accuracy and validity of each sensor and/or apparatus that relate to providing such data. For example, if the location and orientation of the machine resolving the data is determined at that time by the environment modelling apparatus EM arranged on the machine in combination with data received from the sensors installed on the machine, the accuracy and/or validity of the data resolved depends on the accuracy and validity of the combination of the data acquired to determine the location and orientation of the machine, as well as the accuracy and validity of any other data regarding the resolving. Here, the accuracy of the data acquired by the environment modelling apparatus EM depends for example on if the machine is stable when tracking and how near or far the tracked surroundings or the tracked reference points or other trackable markers are and how many of them are tracked as well as how accurately their locations are determined.

According to an embodiment, it is further initialized the tracking apparatus by determining location and orientation of the tracking apparatus in at least one of the machine coordinate system or the worksite coordinate system if the tracking apparatus is set on at least one of the machine or another machine, and by determining location and orientation of the tracking apparatus in the worksite coordinate system if the tracking apparatus is set external from any machine.

The initialization of the tracking apparatus TA as such is considered already above in this description. Furthermore, according to this embodiment, in the initialization of the tracking apparatus TA the location and orientation of the tracking apparatus TA may be determined in the machine coordinate system MCS and/or in the worksite coordinate system WCS. If the tracking apparatus TA is arranged in the machine or another machine, the location and orientation of the tracking apparatus TA may be determined either in the machine coordinate system MCS or the worksite coordinate system WCS or both, depending on the tracking apparatus and where it is attached to. If the tracking apparatus uses external positioning system like GNSS, it determines itself in the worksite coordinate system WCS and it is determined in the coordinate system of the machine it is attached to. On the other hand, if the tracking apparatus TA does not use external positioning system and it is attached to a machine, i.e. the machine or another machine, it is determined at least in the coordinate system of the machine it is attached to and additionally in the worksite coordinate system WCS in cases it is used as a tracking apparatus by another machine. In the event of the tracking apparatus TA being arranged external from any machine, the location and orientation of the tracking apparatus TA shall be determined at least in the worksite coordinate system WCS.

According to an embodiment, it is further initialized the environment modelling apparatus by determining location and orientation of the environment modelling apparatus in at least one of the machine coordinate system or the worksite coordinate system if the environment modelling apparatus is set on at least one of the machine or another machine, and by determining the location and orientation of the environment modelling apparatus in the worksite coordinate system if the environment modelling apparatus is set external from any machine.

The description relating to the initialization of the tracking apparatus TA above is correspondingly applicable to the initialization of the environment modelling apparatus EM as well. Furthermore, according to this embodiment, in the initialization of the environment modelling apparatus EM the location and orientation of the environment modelling apparatus EM may be determined in the machine coordinate system MCS and/or the worksite coordinate system WCS. If the environment modelling apparatus EM is arranged in the machine or another machine, the location and orientation of the environment modelling apparatus EM may be determined either in the machine coordinate system MCS or the worksite coordinate system WCS or both, depending on the environment modelling apparatus and where it is attached to. If the environment modelling apparatus uses external positioning system like GNSS, it determines itself in the worksite coordinate system WCS and it is determined in the coordinate system of the machine it is attached to. On the other hand, if the environment modelling apparatus EM does not use external positioning system and it is attached to a machine, i.e. the machine or another machine, it is determined at least in the coordinate system of the machine it is attached to and additionally in the worksite coordinate system WCS in cases it is used by another machine. In the event of the environment modelling apparatus EM being arranged external from any machine, the location and orientation of the environment modelling apparatus EM shall be determined at least in the worksite coordinate system WCS.

According to an embodiment, the determined situational awareness is at least one of spatial data, georeferenced spatial data, regional work phase and/or work stage data, as-built data, at least one of: location, orientation, direction of travel or alternative direction of travel of any machine in the worksite, at least one of location, orientation or direction of travel or alternative direction of travel or surrounding at least one of: static or moving at least one of: machine, obstacle or object at least one of: to be avoided or of interest.

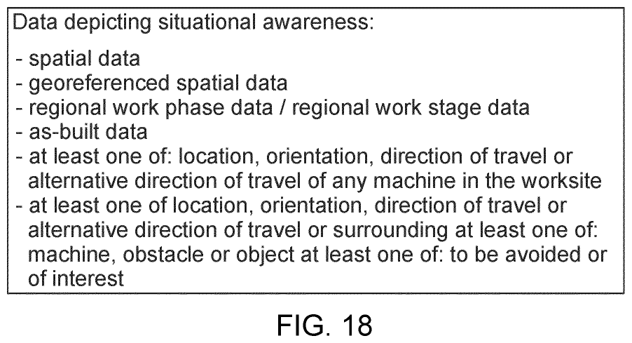

FIG. 18 discloses schematically some data depicting or providing situational awareness in the worksite 13. The determined situational awareness may comprise or include a number of different data or pieces of information, depending on the worksite or a specific part thereof.

Some examples of data, or pieces of information, that may form at least part of the spatial data, georeferenced spatial data, regional data, as-built data or at least one of location, orientation, direction of travel or alternative direction of travel of any machine in the worksite 13 have already been discussed above in this description.

Instead of the data disclosed in the preceding paragraph, or in addition to that, data or pieces of information relating to at least one of location, orientation or direction of travel or alternative direction of travel or surrounding static or moving machine, obstacle or object may also be used to determine or indicate the situational awareness in the worksite 13. The machine, obstacle or object disclosed may be either static or moving. The obstacle herein refers to objects that may be either static or moving but, in any case, objects that are to be avoided either actively by skirting or passively by giving way, for example. The object herein, in turn, may refer to an on object to be avoided such as the obstacle above, or to an object of interest, that may intentionally be approach, such as material to be used in the work to be carried out by the machine.

According to an embodiment, the at least one tracking apparatus tracks with respect to the tracking apparatus locations of at least one of: at least one reference point in the worksite, at least one marker point attached to the machine or any other trackable marker attached to at least one of: the machine, the obstacle or the object; and the at least one environment modelling apparatus tracks with respect to the at least one environment modelling apparatus locations of at least one of: at least one reference point in the worksite, at least one marker point attached to the machine, any other trackable marker attached to at least one of: the machine, the obstacle or the object or spatial data relating to the worksite.

According to this embodiment the at least one tracking apparatus TA is configured to track with respect to the tracking apparatus TA location of at least one reference point RP in the worksite 13 and/or at least one marker point MP attached to the machine. Alternatively to the at least one of these, or in addition to the at least one of these, the at least one tracking apparatus TA is configured to track location of any other trackable marker attached to the machine and/or the obstacle and/or the object. Any other trackable marker may for example be marker attached to a large stone, solid rock or to a large tree or to any fairly static object, which marker may serve as unofficial reference point which may be used as an additional trackable marker used for assisting the determination of the location and orientation of a machine. These may be used especially in areas where is smaller amount of trackable reference points RP available. A machine could resolve an accurate location of such marker in the worksite coordinate system WCS and/or world coordinate system WLCS and after resolving it, transmitting it for example to a worksite computer and/or to a cloud service and/or memory, database or data structure suitable for saving the data as part of data related to the trackable marker and/or as data receivable by at least one position determination unit PDU. This kind of data should contain also information regarding the accuracy and/or validity of the data, since for example the rock may have moved a bit regarding some work task close to the rock or the trackable marker may be changed to another location by a worker. In the latter case the worker moving the trackable marker should also remove the resolved location saved for the trackable marker from the locations it was saved. The tracking provided by the tracking apparatus TA operates as disclosed in embodiments above.

Furthermore, according to this embodiment the at least one environment modelling apparatus EM is configured to track with respect to the at least one environment modelling apparatus EM location of at least one reference point RP in the worksite 13 and/or at least one marker point MP attached to the machine. Alternatively to the at least one of these, or in addition to the at least one of these, the at least one environment modelling apparatus EM is configured to track location of any other trackable marker attached to the machine and/or the obstacle and/or the object, and/or spatial data relating to the worksite 13, wherein the spatial data relating to the worksite 13 may for example be natural landmarks such as trees and/or large stones and/or solid rock and/or smaller stones and/or other landmarks such as unmoving objects and/or tools and/or buildings and/or warehouses and/or tree stumps. It should be noted that the environment modelling apparatus EM may use a number of landmarks for keeping track of the location and orientation of the machine, meaning that if location and orientation is at one time instant determined, the environment modelling apparatus EM may use these landmarks to determine the location and orientation of the machine after the time instant the location and orientation was determined by determining how much the location and orientation of the machine changed after the time instant when the location and orientation was determined with respect to these landmarks. Then, the environment modelling apparatus EM may continue this kind of tracking of the location and orientation of the machine on and on without necessarily detecting such reference points and/or other trackable marker points the locations of which is known in the model. Naturally, the accuracy of the determined location and orientation of the machine decreases when such tracking is prolonged where no reference points and other trackable marker points are detected. The operator may be informed regarding such decreasing. The tracking taken place by the at least one environment modelling apparatus EM may operate similarly as the tracking taken place by the at least one tracking apparatus. Therefore, the specification above relating to the tracking apparatuses TA is in this respect applicable to the environment modelling apparatus EM as well.

According to an embodiment, the method for determining the situational awareness in the worksite further comprises determining a minimum level of accuracy of the determined location and orientation of the machine in the worksite, determining a threshold level above the minimum level of accuracy, and wherein the controls for moving an under carriage of the machine are disabled if the level of accuracy falls below the threshold level and if the work task in progress may be carried out without moving the under carriage.

This embodiment herein relates especially to machines with a movable carriage comprising an under carriage and an upper carriage that are able to move relative to each other, such as to rotate relative to each other like in excavators. According to this embodiment it is determined the minimum level of accuracy of the determined location and orientation of the machine which is required for allowing all the possible operations of the work machine to operate in full. If this minimum level of accuracy of the determined location and orientation of the machine is not achieved, the machine may be allowed to operate with limited operations. Therefore, it is additionally determined the threshold level for the accuracy of the determined location and orientation of the machine, and in response to the level of the accuracy of the determined location and orientation of the machine falling below the threshold level the operations of the machine may be limited such that the machine may continue its operation but it is not allowed to move from its present location in the worksite 13. In the event of the machine being the excavator 1 this means that the under carriage 2a of the excavator 1 is not allowed to move but the excavator 1 may continue its operation as long as it does not need to move from its present location.

According to an embodiment, the data related to at least one of: the at least one tracking apparatus or the at least one environment modelling apparatus comprises at least one of: the data acquired by the respective apparatus, data from sensors installed on the respective apparatus, data from sensors installed on the attachment point of the apparatus, data resolved by at least one of: any position determination unit or any apparatus at least one of: by tracking the respective apparatus or as a result of any calculations relating to the respective apparatus or at least one of: accuracy level or validity of at least one of the previous.

According to this embodiment, the data related to the at least one tracking apparatus TA and/or the at least one environment modelling apparatus EM comprises the data acquired by the respective apparatus and/or data from possible sensors installed on the respective apparatus, the sensors having been discussed in more detail already above in this description. Alternatively, or additionally, the data related to the at least one tracking apparatus TA and/or the at least one environment modelling apparatus EM may comprise data from sensors installed on the attachment point of the apparatus, whereby the sensors may for example provide information about the position and/or orientation and/or inclination and/or heading of the respective apparatus. Alternatively, or additionally, the data related to the at least one tracking apparatus TA and/or the at least one environment modelling apparatus EM may comprise data resolved by any position determination unit and/or any apparatus by tracking the respective apparatus and/or as a result of any calculations relating to the respective apparatus and/or accuracy level and/or validity of at least one of the previously mentioned data herein. Therefore, the data related to the at least one tracking apparatus TA and/or the at least one environment modelling apparatus EM may be retrieved by a number of different ways, such as by tracking operations provided by the respective tracking apparatus(es), resolving the data in the at least one position determination unit or by calculation operations provided for example by the at least one position determination unit, taking into account also the accuracy level and/or validity of the data.

According to an embodiment, if the at least one tracking apparatus is set on the worksite and if it comprises a tracking device for tracking the location of the tracking apparatus with one or more GNSS antennas, the tracking apparatus further comprises at least one of: a camera, a stereocamera, a lidar, a radar or a tachymeter as a tracking device.

According to this embodiment, if the tracking apparatus TA is set on the worksite 13 and if it comprises a tracking device TD for tracking the location of the tracking apparatus TA with one or more GNSS antennas, it is also provided with at least one camera and/or at least one stereocamera and/or at least one lidar and/or at least one radar and/or at least one tachymeter as a further tracking device TD for tracking the location and orientation of the machine in the worksite 13, and at the same time, for tracking the location and orientation of other objects or obstacles in the worksite 13. Especially the radar may also be used to track invisible objects, such as underground constructions.

According to an embodiment, for determining the situational awareness in the worksite, the at least one position determination unit is configured to determine the location and orientation of the machine in the worksite additionally based at least in part on data received from one or more sensors installed on the machine and/or another machine; wherein the sensors comprise at least one of: position, orientation, inclination, heading or distance travelled of the machine and/or another machine. According to this embodiment the determination of the location and orientation of the machine may be additionally based at least in part on sensor data that describes position and/or orientation and/or inclination and/or heading and/or distance travelled of the machine the location and orientation of which is to be determined, and/or of another machine, if the data relating to the another machine is utilized for determining the location and orientation of the machine in question.

According to an embodiment for determining the situational awareness in the worksite, the machine is an excavator and the at least one position determination unit PDU is additionally configured to determine the location and orientation of the machine in the worksite based at least in part on data received from one or more sensors installed on the upper carriage of the machine and/or another machine, wherein the sensors comprise position and/or orientation and/or inclination and/or heading of the upper carriage of the machine and/or another machine. According to this embodiment the machine is the excavator 1 and the determination of the location and orientation of the excavator 1 may be additionally based at least in part on sensor data that describes the position and/or orientation and/or inclination and/or heading of the upper carriage 2b of the excavator 1 the location and orientation of which is to be determined, and/or of another excavator 1, if the data relating to the another excavator 1 is utilized for determining the location and orientation of the excavator 1 in question.

The excavator 1 is an example of a mobile earthworks machine in connection with which the solution for determining location and orientation of the machine in a worksite, as well as for determining situational awareness in the worksite, may be utilized. In addition to the excavators like that the solution disclosed herein could also be utilized for example in mobile cranes comprising a carriage part arranged to rotate relative to the rest of the mobile crane, and wherein the rotatable carriage part comprises a lifting boom, and a hook at the distal end of the boom providing a working tool of the crane. The solution for determining location and orientation of the machine in the worksite and the situational awareness in the worksite is substantially similar in the mobile cranes. Other machines, in addition to the excavators and mobile cranes, wherein the disclosed solution could also be utilized, are for example dozers, wheel loader, rollers, backhoes, dump trucks, forwarders, harvesters and the like.

It will be obvious to a person skilled in the art that, as the technology advances, the inventive concept can be implemented in various ways. The invention and its embodiments are not limited to the examples described above but may vary within the scope of the claims.

What is claimed is:

1. A method for determining situational awareness in a worksite, the method comprising:
setting at least one environment modelling apparatus at least one of: on a machine or external from the machine for at least detecting surrounding areas as spatial data of or relating to the worksite, wherein the spatial data is at least surface profile of a ground;
setting at least one tracking apparatus at least one of: on the machine for at least tracking at least one reference point or external from the machine for at least tracking at least one reference point and at least one marker point, wherein the at least one reference point is in the worksite and the at least one marker point is attached to the machine;
acquiring data by the at least one tracking apparatus by tracking reference point and marker point locations with respect to the tracking apparatus;
acquiring data by the at least one environment modelling apparatus—by tracking with respect to the at least one environment modelling apparatus spatial data of or relating to the worksite;
receiving by at least one position determination unit
data related to the at least one tracking apparatus comprising at least the data acquired by the at least one tracking apparatus and
data related to the at least one environment modelling apparatus comprising at least the data acquired by the environment modelling apparatus; and
determining by the at least one position determination unit, based at least in part on the received data, the location and orientation of the machine in the worksite.

2. The method according to claim 1, further comprising
determining by the at least one position determination unit, based at least in part on the received data, at least one of: direction of travel or alternative direction of travel of the machine in the worksite.

3. The method according to claim 1, further comprising
determining at least one of: accuracy level or validity of the determined location and orientation of the machine in the worksite.

4. The method according to claim 1, wherein the data related to the at least one tracking apparatus further comprises at least one of: inclination angle of the tracking apparatus, heading of the tracking apparatus, stability of the tracking apparatus, location and orientation of the tracking apparatus in at least one of: a machine coordinate system, a worksite coordinate system or a world coordinate system or at least one of: accuracy level or validity of at least one of the previous.

5. The method according to claim 1, wherein the data related to the at least one environment modelling apparatus is further at least one of: locations of tracked marker points with respect to the environment modelling apparatus, locations of tracked reference points with respect to the environment modelling apparatus, inclination angle of the environment modelling apparatus, heading of the environment modelling apparatus, stability of the environment modelling apparatus, location and orientation of the environment modelling apparatus in at least one of: a machine coordinate system, a worksite coordinate system or a world coordinate system or at least one of: accuracy level or validity of at least one of the previous.

6. The method according to claim 5, wherein the spatial data comprises at least one of: pictorial data, point cloud data or data with implicit or explicit reference to a location relative to at least one of: the worksite or the Earth.

7. The method according to claim 1, further comprising:
receiving by at least one environment modelling unit
an indication of a material delivery,
rial delivery base determined by first data related to at least one environment modelling apparatus covering an area of material to be placed, and
material delivery complete determined by second data related to at least one environment modelling apparatus covering the area of material to be placed; and
saving by the at least one environment modelling unit at least in part the data regarding the indication of the material delivery, the material delivery base and the material delivery complete as a material delivered.

8. The method according to claim 1, further comprising:
receiving by the at least one environment modelling unit
one or more indications relating to at least one of: work phase or work stage of respective areas, and
data related to the at least one environment modelling apparatus, and wherein by taking into account the one or more indications
it is derived from the data related to the at least one environment modelling apparatus a georeferenced spatial data of respective areas; and
saved at least in part the georeferenced spatial data.

9. The method according to claim 8, wherein the step of saving at least in part the georeferenced spatial data further comprises:
determining, based at least in part on the data received from the at least one environment modelling apparatus, the areas the georeferenced spatial data of which is to be saved; and saving the georeferenced spatial data of the areas determined to be saved.

10. The method according to claim 9, wherein the step of determining, based at least in part on the data received from the at least one environment modelling apparatus, the areas the georeferenced spatial data of which are to be saved, further comprises
detecting the areas where the georeferenced spatial data of the at least one environment modelling apparatus is obstacle-free and regarding the obstacle-free areas, the method further comprising:
comparing current accuracy of the determined location and orientation of the machine in the worksite with the accuracy of the determined location and orientation of the machine in the worksite in time of the previously saved georeferenced spatial data; and
whether the current accuracy is above almost as good, updating the saved georeferenced spatial data in the obstacle-free areas.

11. The method according to claim 1, further comprising:
resolving, by the at least one position determination unit which determined the location and orientation of the machine in the worksite, data regarding at least one of: a tracking apparatus, an environment modelling apparatus, an object or another machine; and
transmitting the data resolved at least one of:
as part of data related to the respective tracking apparatus, environment modelling apparatus, object or another machine; or
as data receivable by at least one position determination unit.

12. The method according to claim 1, wherein the method further comprises:
initializing the tracking apparatus by
determining-location and orientation of the tracking apparatus in at least one of: the machine coordinate system or the worksite coordinate system if the tracking apparatus is set on at least one of: the machine or another machine; and
determining location and orientation of the tracking apparatus in the worksite coordinate system if the tracking apparatus is set external from any machine.

13. The method according to claim 1, further comprising
initializing the environment modelling apparatus by
determining location and orientation of the environment modelling apparatus in at least one of: the machine coordinate system or the worksite coordinate system if the environment modelling apparatus is set on at least one of: the machine or another machine, and
determining the location and orientation of the environment modelling apparatus in the worksite coordinate system if the environment modelling apparatus is set external from any machine.

14. The method according to claim 1, wherein the determined situational awareness is at least one of spatial data, georeferenced spatial data, regional work phase data, regional work stage data, as-built data, at least one of: location, orientation, direction of travel or alternative direction of travel of any machine in the worksite, at least one of location, orientation or direction of travel or alternative direction of travel or surrounding at least one of: static or moving at least one of: machine, obstacle or object at least one of: to be avoided or of interest.

15. The method according to claim 1, wherein
the at least one tracking apparatus further tracks, with respect to the tracking apparatus, locations of any other trackable marker attached to at least one of: the machine, the obstacle or the object, and
the at least one environment modelling apparatus further tracks, with respect to the at least one environment modelling apparatus, locations of at least one of: at least one reference point in the worksite, at least one marker point attached to the machine, any other trackable marker attached to at least one of: the machine, the obstacle or the object.

16. The method according to claim 1, further comprising:
determining a minimum level of accuracy of the determined location and orientation of the machine in the worksite; and
determining a threshold level above the minimum level of accuracy, and wherein
it is disabled the controls for moving an under carriage of the machine if the level of accuracy falls below the threshold level and if the work task in progress may be carried out without moving the under carriage.

17. The method according to claim 1, wherein the data related to at least one of: the at least one tracking apparatus or the at least one environment modelling apparatus further comprises at least one of: data from sensors installed on the respective apparatus, data from sensors installed on the attachment point of the apparatus, data resolved by at least one of: any position determination unit or any apparatus at least one of: by tracking the respective apparatus or as a result of any calculations relating to the respective apparatus or at least one of: accuracy level or validity of at least one of the previous.

18. The method according to claim 1, wherein
if the at least one tracking apparatus is set on the worksite and if it comprises a tracking device for tracking the location of the tracking apparatus with one or more GNSS antennas,
the tracking apparatus further comprises at least one of: a camera, a stereocamera, a lidar, a radar or a tachymeter as a tracking device.

19. The method according to claim 1, wherein
determination, by the at least one position determination unit, of the location and orientation of the machine in the worksite is additionally based at least in part on data received from one or more sensors installed on at least one of: the machine or another machine; wherein the sensors comprise at least one of: position, orientation, inclination, heading or distance travelled of at least one of: the machine or another machine.

20. The method according to claim 1, wherein
the machine is an excavator; and wherein
determination, by the at least one position determination unit, of the location and orientation of the machine in the worksite is additionally based at least in part on data received from one or more sensors installed on the upper carriage of at least one of: the machine-or another machine, wherein
the sensors comprise at least one of: position, orientation, inclination or heading of the upper carriage of at least one of: the machine or another machine.
